(19) United States
(12) Patent Application Publication
(10) Pub. No.: US 2026/0309832 A1
(43) Pub. Date: Oct. 8, 2026

(54) UNEVENLY SPACED TIME-DOMAIN RESOURCE ASSIGNMENT OF A SENSING SIGNAL FOR OBJECT SPEED

(71) Applicant: QUALCOMM Incorporated, San Diego, CA (US)

(72) Inventors: Min HUANG, Beijing (CN); Mingxi YIN, Beijing (CN); Jing DAI, Beijing (CN); Liangming WU, Beijing (CN); Chao WEI, Beijing (CN); Hao XU, Beijing (CN)

(21) Appl. No.: 19/481,846

(22) PCT Filed: Jun. 15, 2023
(86) PCT No.: PCT/CN2023/100343

§ 371 Date: Nov. 5, 2025

(51) Int. Cl. G01S 7/00; G01S 13/58; H04W 72/23

(52) U.S. Cl. CPC G01S 7/003; G01S 13/58; H04W 72/23

(57) ABSTRACT

Methods, systems, and devices for wireless communication are described. A first user equipment (UE) may receive control signaling indicating a set of unevenly spaced time domain occasions within a time duration to monitor for a sensing signal associated with estimating a speed of an object, where in the set of unevenly spaced time domain occasions, a first time gap between a first pair of consecutive time domain occasions is different than a second time gap between a second pair of consecutive time domain occasions. The UE may monitor, within the time duration, for a first reflected sensing signal during the set of unevenly spaced time domain occasions, and the UE may transmit a report indicating a Doppler frequency, an estimated speed of the object corresponding to the Doppler frequency, or both, based on monitoring for the first reflected sensing signal.

### CROSS REFERENCE

The present Application for Patent is a 371 national phase filing of International Patent Application No. PCT/CN2023/100343 by HUANG et al., entitled “UNEVENLY SPACED TIME-DOMAIN RESOURCE ASSIGNMENT OF A SENSING SIGNAL FOR OBJECT SPEED,” filed Jun. 15, 2023, assigned to the assignee hereof, and expressly incorporated by reference herein.

### FIELD OF TECHNOLOGY

The present disclosure relates to wireless communication, including unevenly spaced time-domain resource assignments for sensing signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support unevenly spaced time-domain resource assignments for sensing signals. For example, the described techniques provide for a first UE to receive control signaling indicating a set of unevenly spaced time domain occasions within a time duration to monitor for a sensing signal associated with estimating a speed of an object, where in the set of unevenly spaced time domain occasions, a first time gap between a first pair of consecutive time domain occasions is different than a second time gap between a second pair of consecutive time domain occasions. The UE may monitor, within the time duration, for a first reflected sensing signal during the set of unevenly spaced time domain occasions, and the UE may transmit a report indicating a Doppler frequency, an estimated speed of the object corresponding to the Doppler frequency, or both, based on monitoring for the first reflected sensing signal.

A method for wireless communications by a UE is described. The method may include receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, monitoring, within the time duration, for a first reflected sensing signal during the set of unevenly spaced time domain occasions, and transmitting a report indicating a Doppler frequency, an estimated speed of the object corresponding to the Doppler frequency, or both, based on monitoring for the first reflected sensing signal.

A UE for wireless communications by a UE is described. The UE may include one or more processors and one or more memories coupled with the one or more processors. The one or more processors may be configured to cause the UE to receive control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, monitor, within the time duration, for a first reflected sensing signal during the set of unevenly spaced time domain occasions, and transmit a report indicating a Doppler frequency, an estimated speed of the object corresponding to the Doppler frequency, or both, based on monitoring for the first reflected sensing signal.

Another UE for wireless communications by a UE is described. The UE may include means for receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, means for monitoring, within the time duration, for a first reflected sensing signal during the set of unevenly spaced time domain occasions, and means for transmitting a report indicating a Doppler frequency, an estimated speed of the object corresponding to the Doppler frequency, or both, based on monitoring for the first reflected sensing signal.

A non-transitory computer-readable medium storing code for wireless communications by a UE is described. The code may include instructions executable by a processor to receive control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, monitor, within the time duration, for a first reflected sensing signal during the set of unevenly spaced time domain occasions, and transmit a report indicating a Doppler frequency, an estimated speed of the object corresponding to the Doppler frequency, or both, based on monitoring for the first reflected sensing signal.

Some examples of the method, UEs, and non-transitory computer-readable medium described herein may further include operations, features, means, or instructions for monitoring, within the time duration, for a second reflected sensing signal associated with estimating a speed of a second object during the set of unevenly spaced time domain occasions, where the report indicates a second Doppler frequency, an estimated speed of the second object corresponding to the second Doppler frequency, or both, based on the second reflected sensing signal.

In some examples of the method, UEs, and non-transitory computer-readable medium described herein, receiving the control signaling may include operations, features, means, or instructions for receiving the control signaling indicating an index identifying a position within the time duration for each time domain occasion of the set of unevenly spaced time domain occasions.

In some examples of the method, UEs, and non-transitory computer-readable medium described herein, receiving the control signaling may include operations, features, means, or instructions for receiving the control signaling indicating that a time gap between any pair of consecutive time domain occasions of the set of unevenly spaced time domain occasions may be different than a time gap between any other pair of consecutive time domain occasions of the set of unevenly spaced time domain occasions.

In some examples of the method, UEs, and non-transitory computer-readable medium described herein, the monitoring may include operations, features, means, or instructions for monitoring, within the time duration, for the first reflected sensing signal during the set of unevenly spaced time domain occasions based on the sparse array formula and the one or more parameters, where a first subset of the set of unevenly spaced time domain occasions includes a subset of time domain occasions of a first uniform array, and a second subset of the set of unevenly spaced time domain occasions includes a subset of time domain occasions of a second uniform array.

In some examples of the method, UEs, and non-transitory computer-readable medium described herein, the sparse array formula includes a nested array formula and the one or more parameters include a quantity of elements associated with the set of unevenly spaced time domain occasions.

In some examples of the method, UEs, and non-transitory computer-readable medium described herein, the sparse array formula includes a co-prime array formula and the one or more parameters include a pair of co-prime integers.

In some examples of the method, UEs, and non-transitory computer-readable medium described herein, the control signaling indicates a set of uniform time domain occasions and the method, UEs, and non-transitory computer-readable medium may include further operations, features, means, or instructions for receiving a control message indicating to monitor the sensing signal during the set of unevenly spaced time domain occasions.

In some examples of the method, UEs, and non-transitory computer-readable medium described herein, the set of unevenly spaced time domain occasions includes a subset of the set of uniform time domain occasions.

In some examples of the method, UEs, and non-transitory computer-readable medium described herein, the subset of the set of uniform time domain occasions may be based on a sparse array formula, one or more parameters, and a maximum quantity for generation of a sparse array that may have a latest time domain occasion of the set of unevenly spaced time domain occasions that occurs within a time duration of a uniform array.

In some examples of the method, UEs, and non-transitory computer-readable medium described herein, the control signaling indicates a set of uniform time domain occasions and the method, UEs, and non-transitory computer-readable medium may include further operations, features, means, or instructions for receiving a control message indicating to monitor the sensing signal during the set of uniform time domain occasions.

Some examples of the method, UEs, and non-transitory computer-readable medium described herein may further include operations, features, means, or instructions for calculating the Doppler frequency based on a time-domain channel covariance matrix associated with the first reflected sensing signal.

Some examples of the method, UEs, and non-transitory computer-readable medium described herein may further include operations, features, means, or instructions for calculating the Doppler frequency may be based on obtaining a difference co-array-domain channel covariance matrix associated with the first reflected sensing signal.

Some examples of the method, UEs, and non-transitory computer-readable medium described herein may further include operations, features, means, or instructions for calculating the Doppler frequency may be based on obtaining a difference co-array-domain channel response vector associated with the first reflected sensing signal.

In some examples of the method, UEs, and non-transitory computer-readable medium described herein, the control signaling includes radio resource control signaling that indicates a periodic sensing signal configuration identifying the set of unevenly spaced time domain occasions.

In some examples of the method, UEs, and non-transitory computer-readable medium described herein, the control signaling includes a medium access control-control element (MAC-CE) message or a downlink control information message that indicates an aperiodic sensing signal configuration identifying the set of unevenly spaced time domain occasions.

A method for wireless communications by a wireless communication device is described. The method may include transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, transmitting, within the time duration, a sensing signal via the set of unevenly spaced time domain occasions, and receiving a report indicating a Doppler frequency, an estimated speed of the object corresponding to the Doppler frequency, or both, based on transmitting the sensing signal.

A wireless communication device for wireless communications by a wireless communication device is described. The wireless communication device may include one or more processors and one or more memories coupled with the one or more processors. The one or more processors may be configured to cause the wireless communication device to transmit control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, transmit, within the time duration, a sensing signal via the set of unevenly spaced time domain occasions, and receive a report indicating a Doppler frequency, an estimated speed of the object corresponding to the Doppler frequency, or both, based on transmitting the sensing signal.

Another wireless communication device for wireless communications by a wireless communication device is described. The wireless communication device may include means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, means for transmitting, within the time duration, a sensing signal via the set of unevenly spaced time domain occasions, and means for receiving a report indicating a Doppler frequency, an estimated speed of the object corresponding to the Doppler frequency, or both, based on transmitting the sensing signal.

A non-transitory computer-readable medium storing code for wireless communications by a wireless communication device is described. The code may include instructions executable by a processor to transmit control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions, transmit, within the time duration, a sensing signal via the set of unevenly spaced time domain occasions, and receive a report indicating a Doppler frequency, an estimated speed of the object corresponding to the Doppler frequency, or both, based on transmitting the sensing signal.

In some examples of the method, wireless communication devices, and non-transitory computer-readable medium described herein, the report indicates a second Doppler frequency, an estimated speed of a second object corresponding to the second Doppler frequency, or both.

In some examples of the method, wireless communication devices, and non-transitory computer-readable medium described herein, transmitting the control signaling may include operations, features, means, or instructions for transmitting the control signaling indicating an index identifying a position within the time duration for each time domain occasion of the set of unevenly spaced time domain occasions.

In some examples of the method, wireless communication devices, and non-transitory computer-readable medium described herein, transmitting the control signaling may include operations, features, means, or instructions for transmitting the control signaling indicating that a time gap between any pair of consecutive time domain occasions of the set of unevenly spaced time domain occasions may be different than a time gap between any other pair of consecutive time domain occasions of the set of unevenly spaced time domain occasions.

In some examples of the method, wireless communication devices, and non-transitory computer-readable medium described herein, the control signaling indicates a sparse array formula and one or more parameters, and a first subset of the set of unevenly spaced time domain occasions includes a subset of time domain occasions of a first uniform array, and a second subset of the set of unevenly spaced time domain occasions includes a subset of time domain occasions of a second uniform array.

In some examples of the method, wireless communication devices, and non-transitory computer-readable medium described herein, the sparse array formula includes a nested array formula and the one or more parameters include a quantity of elements associated with the set of unevenly spaced time domain occasions.

In some examples of the method, wireless communication devices, and non-transitory computer-readable medium described herein, the sparse array formula includes a co-prime array formula and the one or more parameters include a pair of co-prime integers.

In some examples of the method, wireless communication devices, and non-transitory computer-readable medium described herein, the control signaling indicates a set of uniform time domain occasions and the method, wireless communication devices, and non-transitory computer-readable medium may include further operations, features, means, or instructions for transmitting a control message indicating to monitor the sensing signal during the set of unevenly spaced time domain occasions.

In some examples of the method, wireless communication devices, and non-transitory computer-readable medium described herein, the set of unevenly spaced time domain occasions includes a subset of the set of uniform time domain occasions.

In some examples of the method, wireless communication devices, and non-transitory computer-readable medium described herein, the subset of the set of uniform time domain occasions may be based on a sparse array formula, one or more parameters, and a maximum quantity for generation of a sparse array that may have a latest time domain occasion of the set of unevenly spaced time domain occasions that occurs within a time duration of a uniform array.

In some examples of the method, wireless communication devices, and non-transitory computer-readable medium described herein, the control signaling indicates a set of uniform time domain occasions and the method, wireless communication devices, and non-transitory computer-readable medium may include further operations, features, means, or instructions for transmitting a control message indicating to monitor the sensing signal during the set of uniform time domain occasions.

In some examples of the method, wireless communication devices, and non-transitory computer-readable medium described herein, the control signaling includes radio resource control signaling that indicates a periodic sensing signal configuration identifying the set of unevenly spaced time domain occasions.

In some examples of the method, wireless communication devices, and non-transitory computer-readable medium described herein, the control signaling includes a MAC-CE message or a downlink control information message that indicates an aperiodic sensing signal configuration identifying the set of unevenly spaced time domain occasions.

### BRIEF DESCRIPTION OF THE DRAWINGS

FIG. 1 shows an example of a wireless communications system that supports unevenly spaced time-domain resource assignments for sensing signals in accordance with one or more aspects of the present disclosure.

FIG. 2 shows an example of a wireless communications system that supports unevenly spaced time-domain resource assignments for sensing signals in accordance with one or more aspects of the present disclosure.

FIG. 3 shows an example of an occasion diagram that supports unevenly spaced time-domain resource assignments for sensing signals in accordance with one or more aspects of the present disclosure.

FIG. 4 shows an example of a process flow that supports unevenly spaced time-domain resource assignments for sensing signals in accordance with one or more aspects of the present disclosure.

FIGS. 5 and 6 show block diagrams of devices that support unevenly spaced time-domain resource assignments for sensing signals in accordance with one or more aspects of the present disclosure.

FIG. 7 shows a block diagram of a communications manager that supports unevenly spaced time-domain resource assignments for sensing signals in accordance with one or more aspects of the present disclosure.

FIG. 8 shows a diagram of a system including a device that supports unevenly spaced time-domain resource assignments for sensing signals in accordance with one or more aspects of the present disclosure.

FIGS. 9 and 10 show block diagrams of devices that support unevenly spaced time-domain resource assignments for sensing signals in accordance with one or more aspects of the present disclosure.

FIG. 11 shows a block diagram of a communications manager that supports unevenly spaced time-domain resource assignments for sensing signals in accordance with one or more aspects of the present disclosure.

FIG. 12 shows a diagram of a system including a device that supports unevenly spaced time-domain resource assignments for sensing signals in accordance with one or more aspects of the present disclosure.

FIGS. 13 through 15 show flowcharts illustrating methods that support unevenly spaced time-domain resource assignments for sensing signals in accordance with one or more aspects of the present disclosure.

### DETAILED DESCRIPTION

In some examples, a transmitting device (e.g., a UE, a network entity) may transmit a sensing signal to a UE for determining a speed of an object (e.g., a drone, a vehicle, or another object). For example, the sensing signal may be reflected by the object, and the UE may measure a reflected signal at various time occasions to determine a Doppler frequency, which may be used to calculate the speed of the object. The transmitting device (e.g., the network entity or another network entity) may configure the UE with a uniform (e.g., continuous, with a same spacing between occasions) time-domain resource assignment to monitor for the reflected signal. However, a uniform time domain resource assignment may not be necessary for obtaining precise speed measurements and may cause the UE to perform excessive quantities of measurements. As such, techniques for obtaining speed measurements while reducing overhead and power consumption at the UE may be desired.

In accordance with examples as described herein, a transmitting device (e.g., a UE or a network entity) may configure the UE with a set of unevenly spaced time domain occasions (e.g., sparse time domain occasions). In some examples, the UE may receive control signaling indicating both uniform and unevenly spaced time domain occasions and may receive another message that indicates which time domain occasion should be used. In some cases, the set of unevenly spaced time domain occasions may be a subset of the uniform time domain occasions. Additionally, or alternatively, the set of unevenly spaced time domain occasions may be formulated by the UE based on a type of sparse array (e.g., a nested sparse array or a co-prime sparse array) and one or more parameters indicated to the UE. In some cases, the UE may be configured (e.g., pre-configured) with two uniform arrays for formulation of the unevenly spaced time domain occasions. Accordingly, the UE may monitor for a reflected signal during the set of unevenly spaced time domain occasions, which may reduce overhead and power consumption at the UE.

Aspects of the disclosure are initially described in the context of wireless communications systems. Aspects of the disclosure are additionally illustrated with respect to occasion diagrams and process flows. Aspects of the disclosure are further illustrated by and described with reference to apparatus diagrams, system diagrams, and flowcharts that relate to unevenly spaced time-domain resource assignments for sensing signals.

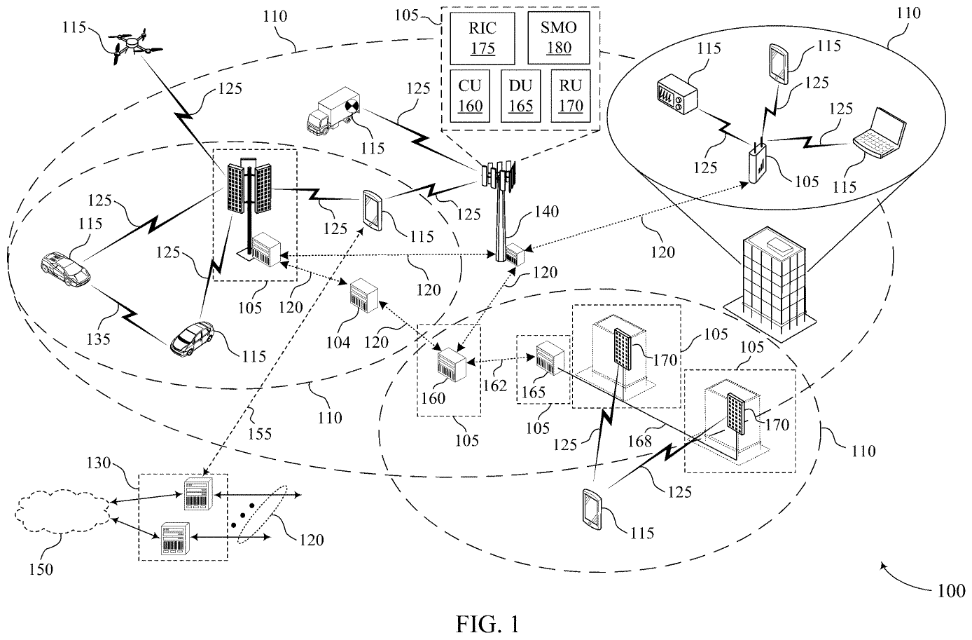

FIG. 1 shows an example of a wireless communications system 100 that supports unevenly spaced time-domain resource assignments for sensing signals in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an [symbol] ₁, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support unevenly spaced time-domain resource assignments for sensing signals as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a transmitting device (e.g., a UE 115, a network entity 105) may transmit a sensing signal to a UE 115 for determining a speed of an object (e.g., a drone, a vehicle, or another object) via bistatic sensing, for example. For example, the sensing signal may be reflected by the object, and the UE 115 may measure a reflected signal at various time occasions to determine a Doppler frequency, which may be used to calculate the speed of the object. The transmitting device (e.g., the network entity 105 or another network entity 105) may configure the UE 115 with a uniform (e.g., continuous, with a same spacing between occasions) time-domain resource assignment to monitor for the reflected signal. However, a uniform time domain resource assignment may not be necessary for obtaining precise speed measurements and may cause the UE 115 to perform excessive quantities of measurements. As such, techniques for obtaining speed measurements while reducing overhead and power consumption at the UE 115 may be desired.

In accordance with examples as described herein, a transmitting device (e.g., a UE 115 or a network entity 105) may configure the UE 115 with a set of unevenly spaced time domain occasions (e.g., sparse time domain occasions). In some examples, the UE 115 may receive control signaling indicating both uniform and unevenly spaced time domain occasions and may receive another message that indicates which time domain occasion should be used. In some cases, the set of unevenly spaced time domain occasions may be a subset of the uniform time domain occasions. Additionally, or alternatively, the set of unevenly spaced time domain occasions may be formulated by the UE 115 based on a type of sparse array (e.g., a nested sparse array or a co-prime sparse array) and one or more parameters indicated to the UE 115. In some cases, the UE 115 may be configured (e.g., pre-configured) with two uniform arrays for formulation of the unevenly spaced time domain occasions. Accordingly, the UE 115 may monitor for a reflected signal during the set of unevenly spaced time domain occasions, which may reduce overhead and power consumption at the UE 115.

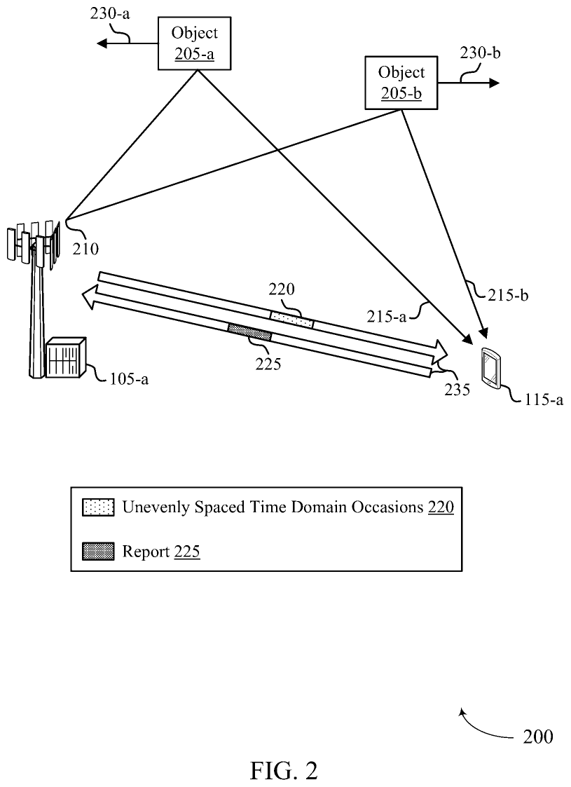

FIG. 2 shows an example of a wireless communications system 200 that supports unevenly spaced time-domain resource assignments for sensing signals in accordance with one or more aspects of the present disclosure. The wireless communications system 200 may include a network entity 105-a and a UE 115-a, which may be examples of corresponding devices as described herein, with reference to FIG. 1. The UE 115-a and the network entity 105-a may communicate via communication links 235, which may be examples of communication links 125 as described herein, with reference to FIG. 1.

In some examples, the network entity 105-a may transmit a sensing signal 210 (e.g., a reference signal) to the UE 115-a for determining a speed 230 of an object 205 (e.g., a drone, a vehicle, or another object). For example, the sensing signal 210 may be transmitted in the direction of an object 205-a and may be reflected by the object 205-a. The UE 115-a may then measure a reflected signal 215-a at various time occasions to determine a Doppler frequency, which may be used to calculate the speed of the object 205-a.

In some cases, the network entity 105-a may configure the UE 115 with a set of uniform time domain occasions. The uniform time domain occasions may have even or equal spacing between consecutive time domain occasions. For example, a time gap between a first pair of consecutive time domain occasions may be the same as a time gap between any other pair of consecutive time domain occasions of the set of uniform time domain occasions. However, using the set of uniform time domain occasions for determining a speed 230 of an object (e.g., via bistatic sensing) may not be necessary for obtaining precise speed measurements, and may instead cause the UE 115-a to perform excessive quantities of measurements. As such, techniques for obtaining measurements of the speed 230 of an object 205 while reducing overhead and power consumption at the UE 115-a may be desired.

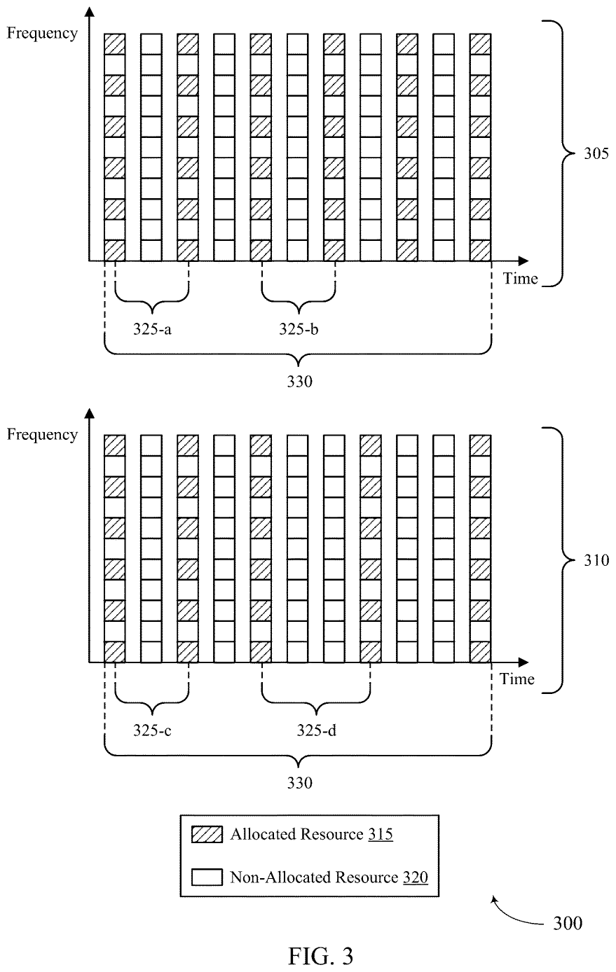

In accordance with examples as described herein, the network entity 105-a may configure the UE 115-a with a set of unevenly spaced (e.g., sparse) time domain occasions 220 (e.g., a set of reference signal resources, such as channel state information reference signal (CSI-RS) resources or tracking reference signal (TRS) resources). Relative to the set of uniform time domain occasions, the set of unevenly spaced time domain occasions 220 may be within a same time interval (e.g., a time duration 330, as illustrated in FIG. 3), but there may be fewer (e.g., sparser) time domain occasions in the set of unevenly spaced time domain occasions 220. Additionally, a time gap (e.g., a time gap 325-d, as illustrated in FIG. 3) between a first pair of consecutive time domain occasions of the set of unevenly spaced time domain occasions 220 may be different from a time gap (e.g., a time gap 325-b, as illustrated in FIG. 3) between a second pair of consecutive time domain occasions of the set of unevenly spaced time domain occasions 220. This may result in the UE 115-a monitoring more frequently during some portions of the time interval than during other portions. Examples of uniform time domain occasions and unevenly spaced time domain occasions 220 are illustrated in more detail herein, with reference to FIG. 3. In some examples, the configuration of the set of unevenly spaced time domain occasions 220 may be periodic or aperiodic. Similarly, the set of unevenly spaced time domain occasions 220 may be indicated in an RRC message (e.g., for periodic sensing configuration) or in a MAC-CE message or in downlink control information (DCI) (e.g., for aperiodic sensing configuration).

By monitoring during unevenly spaced time domain occasions 220, the quantity of time domain occasions for monitoring are reduced, the UE 115-a may reduce resource consumption and power consumption while still maintaining a similar precision for speed estimation procedures. Further, as a minimum inter-occasion interval (e.g., time gap between consecutive occasions) is the same for uniform time domain occasions and unevenly spaced time domain occasions 220, a range for speed 230 estimation remains the same. For example, the network entity 105-a may transmit the sensing signal 210, which may be reflected by the object 205-a traveling at a speed 230-a. The UE 115-a may monitor for the reflected signal 215-a during the unevenly spaced time domain occasions 220, and the UE 115-a may estimate a Doppler frequency. In some examples, the UE 115-a may calculate (e.g., estimate) the speed 230-a based on the Doppler frequency, and the UE 115-a may transmit a report 225 to the network entity 105-a including the calculated speed 230-a. Alternatively, the UE 115-a may simply include the estimated Doppler frequency in the report 225, and the network entity 105-a may perform a calculation to determine the speed 230-a. In some cases, the UE 115-a may include both the Doppler frequency and the calculated speed 230-a in the report 225.

In some cases, the network entity 105-a may configure the UE 115-a with the set of unevenly spaced time domain occasions 220 but the sensing signal 210 may be transmitted by another transmitting device, such as another UE 115 or another network entity 105. Similarly, the report 225 may be transmitted to the transmitting device, or to the network entity 105-a. For instance, the UE 115-a may receive a control message indicating the unevenly spaced time domain occasions 220 for speed measurement procedures (e.g., via bistatic sensing) from the network entity 105-a, and the UE 115-a may perform the speed measurement procedures at a later (e.g., subsequent) time with another device, such as a second UE 115 via sidelink messages. In some examples, the network entity 15-a may also transmit a message indicating the set of unevenly spaced time domain occasions 220 to the second UE 115, and the network entity 105-a may indicate (e.g., in the message) the second UE 115 to transmit the sensing signal 210. Accordingly, the UE 115-a and the second UE 115 may perform the speed measurement procedures in a cell-control mode, where the network entity 105-a configures the UE 115-a and the second UE 115 with the unevenly spaced-time domain occasions 220 for the speed measurement procedures, and the second UE 115 performs transmission of the sensing signal 210 for reception by the UE 115-a.

Additionally, or alternatively, the UE 115-a and the second UE 115-a may perform speed measurement procedures in an autonomous mode. For example, the second UE 115 may determine a set of unevenly spaced time domain occasions 220, and the UE 115-a may receive a message indicating the set of unevenly spaced time domain occasions 220 from the second UE 115. The UE 115-a may measure a reflected signal 215, as described herein, and may transmit a report 225 to the second UE 115. As such, the UE 115-a and the second UE 115 may perform speed measurement procedures in the autonomous mode (e.g., without involvement from the network entity 105-a), in which the second UE 115 may perform functions of the network entity 105-a, including determining the set of unevenly spaced time domain occasions 220, transmitting a message indicating the unevenly spaced time domain occasions 220 to the UE 115-a, and receiving the report 225, as described herein.

In some examples, the UE 115-a may perform speed measurement procedures for two objects 205 based on a single sensing signal 210. For example, the sensing signal 210 may be reflected by an object 205-b moving with a speed 230-b. The UE 115-a may measure the reflected signal 215-b to perform estimation of the speed 230-b. For example, the UE 115-a may calculate a Doppler frequency associated with the reflected signal 215-b. The UE 115-a may include the Doppler frequency within the report 225 or may transmit a message with a second report 225 that includes the Doppler frequency. Additionally, or alternatively, the UE 115-a may estimate the speed 230-b of the object 205-b and include the estimated speed 230-b in the report 225.

In some examples, the set of unevenly spaced time domain occasions 220 may be associated with a difference co-array, which may correspond to an array including values corresponding to the difference between each element of the unevenly spaced time domain occasions 220. For instance, for an array with values {0, 2, 3, 7}, a corresponding difference co-array may include the values {−7, −5, −4, −3, −2, −1, 0, 1, 2, 3, 4, 5, 7}. The set of unevenly spaced time domain occasions 220 may also be associated with an effective difference co-array, which may be a subset of the difference co-array and may be uniform and continuous. For instance, for the array with values {0, 2, 3, 7}, an effective difference co-array may include the values {−5, −4, −3, −2, −1, 0, 1, 2, 3, 4, 5}, which are uniform and continuous. The UE 115-a may calculate a difference co-array and an effective difference co-array associated with the set of unevenly spaced time domain occasions 220 and may utilize elements in the effective difference co-array as a uniform array (e.g., a uniform linear array (ULA)) for beamforming purposes, which may reduce ambiguity in Doppler frequency estimation and speed measurements.

In some examples, to configure the UE 115-a with the set of unevenly spaced time domain occasions 220, the network entity 105-a may explicitly configure the UE 115-a in a non-formulated manner (e.g., not formulated by the UE 115-a). For example, the network entity 105-a may indicate the UE 115-a (e.g., in a control message) with positions (e.g., in time, such as symbol indices or slot indices) for each time domain occasion of the set of unevenly spaced time domain occasions 220. The positions may be denoted as {t₀, t₁, . . . , t_{N}−1}, where N refers to a quantity of occasions in the set of unevenly spaced time domain occasions 220. In some cases, the inter-occasion intervals may not be common for at least two pairs of consecutive time domain occasions. In some cases, the inter-occasion intervals of two pairs of consecutive time domain occasions may be the same, as long as the inter-occasion intervals of all pairs of consecutive time domain occasions are not all the same. For example, an inter-occasion interval (e.g., d′ᵢ₋ⱼ, where d′ᵢ₋ⱼ=tᵢ−tⱼ) between a first pair of consecutive time domain occasions of the set of unevenly spaced time domain occasions 220 may not be common for a second pair of two occasions (e.g., may be different than an inter-occasion interval between a second pair of consecutive time domain occasions of the set of unevenly spaced time domain occasions 220). In some examples, this may result in the set of the inter-occasion intervals (e.g., the set of {d_{i,j}}) that constitutes a difference co-array that is uniform (e.g., continuous, with a common interval such that

$$\{ {d}_{i , j} \} = [ {d}_{0}^{′} , {d}_{1}^{′} , … , {d}_{M - 1}^{′} ] ) ,$$

which may avoid ambiguity associated with Doppler frequency estimation. For example, the UE 115-a may map the reflected signal 215-a to the uniform difference co-array to estimate the Doppler frequency.

In some other examples, to configure the UE 115-a with the set of unevenly spaced time domain occasions 220, the network entity 105-a may configure the UE 115-a to use a formulated sparse array (e.g., an array for the set of unevenly spaced time domain occasions 220 that is formulated by the UE 115-a) for reception of the sensing signal 210. For example, the network entity 105-a may indicate a sparse array formula (e.g., a type of sparse array, such as nested or co-prime) and one or more parameters to the UE 115-a, and the UE 115-a may generate the set of unevenly spaced time domain occasions 220. For example, the network entity 105-a may indicate a nested array formula type and a parameter N corresponding to a total quantity of sparse array elements (e.g., time domain occasions in the set of unevenly spaced time domain occasions 220). In some cases, the UE 115-a may obtain a parameter N₁ and a parameter N₂ based on the parameter N. For example, for an even value of N, then

$${N}_{1} = {N}_{2} = \frac{N}{2} ,$$

and for an odd value of N, then E

$${N}_{1} = \frac{N - 1}{2} and {N}_{2} = \frac{N + 1}{2} .$$

ach position (e.g., symbol index, slot index) for the set of unevenly spaced time domain occasions 220 may be given by [symbol] = [symbol] ₁∪ [symbol] ₂ where [symbol] ₁ is a uniform array given by Equation 1 below and [symbol] ₂ is a uniform array given by Equation 2 below.

$${𝕊}_{1} = \{ 0 , 1 , … , {N}_{1} - 1 \} \qquad ( 1 )$$

$${𝕊}_{2} = \{ {N}_{1} + ( {N}_{1} + 1 ) i \vert i = 0 , 1 , … , {N}_{2} - 1 \} \qquad ( 2 )$$

For example, for a value of N=6, N₁=N₂=3. As such, the first uniform array may be given by [symbol] ₁={0,1,2} and the second uniform array may be given by [symbol] ₂={3,7,11}, while the set of unevenly spaced time domain occasions 220 may be given by [symbol] ={0,1,2,3,7,11}.

In some other examples, the network entity 105-a may indicate a co-prime array formula type and two co-prime integers P and Q, where P<Q. The UE 115-a may generate each position (e.g., symbol index, slot index) for the set of unevenly spaced time domain occasions 220 based on the pair of co-prime integers. For example, each position of the unevenly spaced time domain occasions 220 may be given by [symbol] = [symbol] ₁ Å [symbol] ₂ where [symbol] ₁ is a uniform array given by Equation 3 below and [symbol] ₂ is a uniform array given by Equation 4 below.

$${𝕊}_{1} = \{ qP \vert q = 0 , 1 , … , Q - 1 \} \qquad ( 3 )$$

$${𝕊}_{2} = \{ pQ \vert p = 0 , 1 , … , 2 P - 1 \} \qquad ( 4 )$$

As such the total quantity of positions for the set of unevenly spaced time domain occasions 220 may be equivalent to Q+2P−1. In an example, for a pair of co-prime integers given by P=3 and Q=5, then [symbol] ₁={0,3,6,9,12} and [symbol] ₂={0,5,10,15,20,25}, which results in an unevenly spaced time domain occasions 220 given by [symbol] ={0,3,5,6,9,10,12,15,20,25}.

In some examples, the network entity 105-a may co-configure the UE 115-a with a set of uniform time domain occasions (e.g., a first CSI-RS resource) in addition to the set of unevenly spaced time domain occasions 220 (e.g., a second CSI-RS resource). For example, the network entity 105-a may configure the set of uniform time domain occasions and the set of unevenly spaced time domain occasions 220 via a first message statically (e.g., via an RRC message) or semi-statically (e.g., via a MAC-CE message), and the network entity 105-a may transmit a second message dynamically (e.g., a DCI message) to indicate the UE 115-a which set to use for measurements. In some examples, which set is used may be based on a sensing constraint. For example, the network entity 105-a may determine that there is a high sensing constraint (e.g., associated with high UE power consumption), and may indicate the UE 115-a to use the set of uniform time domain occasions. Alternatively, the network entity 105-a may determine that there is a low sensing constraint (e.g., associated with low UE power consumption), and may indicate the UE 115-a to use the set of unevenly spaced time domain occasions 220.

In some cases, the network entity 105-a may only indicate a set of uniform time domain occasions to the UE 115-a, and the set of unevenly spaced time domain occasions 220 may be implicitly configured. For example, the set of unevenly spaced time domain occasions 220 may be a subset of the set of uniform time domain occasions. In some examples, the UE 115-a may generate the set of unevenly spaced time domain occasions 220 based on a nested array formula and on a parameter N, which may be implicitly determined by the UE 115-a. For example, the parameter N may be a largest integer (e.g., a maximum quantity) that may be used to generate a nested array (e.g., using Equations 1 and 2 above) with elements that are within the set of uniform time domain occasions. This may result in a set of unevenly spaced time domain occasions 220 with a latest time domain occasions occurring within the set of uniform time domain occasions. In an example, if the set of uniform time domain occasions is given by {0, 1, . . . , 200}, then the parameter N may be 27, resulting in a set of unevenly spaced time domain occasions with positions {0, 1, . . . , 12, 13, 27, . . . , 181, 195}, where the last element (e.g., symbol index, slot index) has a value of 195, which is still within the set of uniform time domain occasions. Meanwhile, a larger value of N (e.g., N=28) would result in a last element of the positions with a value larger than 200.

In some examples, to calculate a Doppler frequency corresponding to a reflected signal 215, the UE 115-a may measure a channel covariance matrix in a time domain based on measuring a reflected signal 215 during the set of unevenly spaced time domain occasions 220. In some cases, the UE 115-a may map the channel covariance matrix in the time domain to a difference co-array domain and use a Multiple Signal Classification (MUSIC)-based formula (e.g., algorithm) to obtain a channel path Doppler frequency associated with a target object 205. Alternatively, the UE 115-a may map a channel covariance vector associated with the channel covariance matrix from the time domain to a difference co-array domain, and the UE 115-a may use a correlation-based formula (e.g., a discrete Fourier transform formula or an inverse discrete Fourier transform formula) to obtain the channel path Doppler frequency associated with the target object 205.

In some examples, the UE 115-a may determine which formula to use based on a length associated with the channel covariance matrix. For example, the UE 115-a may select a MUSIC-based approach if the length is relatively short (e.g., below a threshold value), as MUSIC-based formulas may be associated with high complexity for longer channel covariance matrices. Alternatively, the UE 115-a may select a correlation-based approach is the length is relative long (e.g., above a threshold value), as correlation-based formulas may lead to relatively low resolution estimates for shorter channel covariance matrices.

In some examples, to calculate a Doppler frequency (e.g., using a MUSIC-based approach), the UE 115-a may first measure a received signal given by [symbol] based on measuring a reflected signal 215 during the set of unevenly spaced time domain occasions 220, and the received signal [symbol] may be written as given below in Equation 5.

$${y}_{𝕊} = {H}_{𝕊} x + {n}_{𝕊} \qquad ( 5 )$$

The received signal [symbol] may correspond to an original domain (e.g., a spatial domain).

Using the received signal yₛ, the UE 115-a may calculate a channel covariance matrix [symbol] in the original domain as given below in Equation 6.

$${R}_{𝕊} = E [ {y}_{𝕊} {y}_{𝕊}^{H} ] = {H}_{𝕊} [ \begin{matrix}{a}_{1}^{2} & ⋯ & 0 \\ ⋮ & ⋱ & ⋮ \\ 0 & ⋯ & {a}_{{N}_{t}}^{2}\end{matrix} ] {H}_{𝕊}^{H} + {σ}_{0}^{2} {I}_{N} = [ \begin{matrix}{e}_{0 , 0} & ⋯ & {e}_{0 , N - 1} \\ ⋮ & ⋱ & ⋮ \\ {e}_{N - 1 , 0} & ⋯ & {e}_{N - 1 , N - 1}\end{matrix} ] \qquad ( 6 )$$

where e_{i,j} refers to a correlative coefficient corresponding to two antennas of the UE 115-a, an ith antenna (e.g., at position pᵢ) and a jth antenna (e.g., at position pⱼ), and [symbol] =[ [symbol] ₁, . . . , [symbol] _{N}_{ₜ}].

Based on the channel covariance matrix [symbol] in the original domain, the UE 115-a may derive a channel covariance matrix [symbol] in a transformed domain (e.g., a difference co-array domain), as given below in Equation 7.

$${R}_{{𝕌}_{𝕊}} = E [ {y}_{{𝕌}_{𝕊}} {y}_{{𝕌}_{𝕊}}^{H} ] = {H}_{{𝕌}_{𝕊}} [ \begin{matrix}{a}_{1}^{2} & ⋯ & 0 \\ ⋮ & ⋱ & ⋮ \\ 0 & ⋯ & {a}_{{N}_{t}}^{2}\end{matrix} ] {H}_{{𝕌}_{𝕊}}^{H} + {σ}_{0}^{2} {I}_{{N}_{u}} = [ \begin{matrix}{\tilde{e}}_{0 , 0} & ⋯ & {\tilde{e}}_{0 , {N}_{u} - 1} \\ ⋮ & ⋱ & ⋮ \\ {\tilde{e}}_{{N}_{u} - 1 , 0} & ⋯ & {\tilde{e}}_{{N}_{u} - 1 , {N}_{u} - 1}\end{matrix} ] \qquad ( 7 )$$

where

$${N}_{u} = \frac{\vert {𝕌}_{𝕊} \vert + 1}{2} and {H}_{{𝕌}_{𝕊}} = [ {h}_{{𝕌}_{𝕊} , 1} , … , {h}_{{𝕌}_{𝕊} , {N}_{t}} ] .$$

Here, \tilde{e}_{i,j}=\tilde{e}_{i+k,j+k}, ∀ₖ (e.g., entries in a diagonal line or sub-diagonal line may be the same). Additionally, \tilde{e}_{i,j}=e_{i′, j′} if a position difference between antennas p_{i′}-p_{j′} is equivalent to i−j. The UE 115-a may then perform single or multi-target parameter estimation (e.g., using a MUSIC-based approach) based on the channel covariance matrix [symbol] in the transformed domain.

In some other examples, to calculate a Doppler frequency (e.g., using a correlation-based approach), the UE 115-a may obtain an auto-correlative matrix [symbol] in an original domain (e.g., the spatial domain) based on measuring a reflected signal 215, as given by Equation 8 below.

$${R}_{𝕊} = {H}_{𝕊} [ \begin{matrix}{σ}_{1}^{2} & ⋯ & 0 \\ ⋮ & ⋱ & ⋮ \\ 0 & ⋯ & {σ}_{{N}_{t}}^{2}\end{matrix} ] {H}_{𝕊}^{H} + {σ}_{0}^{2} {I}_{N} \qquad ( 8 )$$

$$where {H}_{𝕊} = [ {h}_{1} , {h}_{2} , … , {h}_{{N}_{t}} ] .$$

The UE 115-a may vectorize the auto-correlative matrix [symbol] in the original domain using a Khatri-Rao product (e.g., a per-column Kronecker product), as given in equation 9 below.

$$v e c ( {R}_{𝕊} ) = ( {H}_{𝕊}^{*} ⊙ {H}_{𝕊} ) [ \begin{matrix}{σ}_{1}^{2} \\ ⋮ \\ {σ}_{{N}_{t}}^{2}\end{matrix} ] + {σ}_{0}^{2} \cdot vec ( {I}_{{N}_{r}} ) = [ [ \begin{matrix}\begin{matrix}{h}_{1} {h}_{1 , 1}^{*} \\ ⋮\end{matrix} \\ {h}_{1} {h}_{1 , N}^{*}\end{matrix} ] , … , [ \begin{matrix}\begin{matrix}{h}_{{N}_{t}} {h}_{{N}_{t} , 1}^{*} \\ ⋮\end{matrix} \\ {h}_{{N}_{t}} {h}_{{N}_{t} , N}\end{matrix} ] ] \cdot [ \begin{matrix}\begin{matrix}{σ}_{1}^{2} \\ ⋮\end{matrix} \\ {σ}_{{N}_{t}}^{2}\end{matrix} ] + {σ}_{0}^{2} \cdot vec ( {I}_{{N}_{r}} ) \qquad ( 9 )$$

where ⊙ denotes the Khatri-Rao product.

The UE 115-a may derive, based on the vectorized auto-correlative matrix [symbol] , a channel response vector [symbol] in a transformed domain (e.g., a difference co-array domain), which may involve combining or averaging rows of the Khatri-Rao product that have identical difference co-array values, and sorting the rows by difference co-array values. The channel response vector [symbol] is given by Equation 10 below.

$${y}_{{𝕌}_{𝕊}} = {H}_{{𝕌}_{𝕊}} \tilde{x} + {n}_{{𝕌}_{𝕊}} \qquad ( 10 )$$

where [symbol] =[\tilde{h}₁, \tilde{h}₂, . . . , \tilde{h}_{N}_{ₜ}]. In some examples, entries in transformed domain (e.g., difference co-array domain) channel vectors \tilde{h}ᵢ may have equal intervals, which may allow the UE 115-a to estimate a parameter per each path using a correlation based approach (e.g., based on a discrete Fourier transform approach or an inverse discrete Fourier transform approach). In some cases, the length of the transformed domain channel vectors \tilde{h}ᵢ may be larger than that of the original domain channel vectors hᵢ, leading to a higher precision for Doppler frequency estimation.

FIG. 3 shows an example of an occasion diagram 300 that supports unevenly spaced time-domain resource assignments for sensing signals in accordance with one or more aspects of the present disclosure. The occasion diagram 300 illustrates uniform time domain occasions 305 (e.g., sparse time domain occasions) and unevenly spaced time domain occasions 310, which may be examples of corresponding concepts as described herein, with reference to FIGS. 1 and 2. Each of the uniform time domain occasions 305 and the unevenly spaced time domain occasions 310 may have one or more allocated resources 315 and one or more non-allocated resources 320.

The uniform time domain occasions 305 may have even or equal spacing between consecutive time domain occasions. For example, a time gap 325-a between a first pair of consecutive time domain occasions of the uniform time domain occasions 305 may be the same as a time gap 325-b between any other pair of consecutive time domain occasions of the uniform time domain occasions 305. This results in an inter-occasion interval being the same in a time domain for a sensing signal measured on the uniform time domain occasions 305 during a time duration 330.

A UE 115 may perform Doppler frequency estimation (e.g., or object speed estimation) based on measuring a sensing signal during the uniform time domain occasions 305. In some examples, to have a relatively high resolution associated with Doppler frequency estimation, a sensing signal time duration should be (e.g., sufficiently) large. Additionally, to have a relatively large Doppler frequency estimation range, an inter-occasion interval (e.g., an inter-pilot interval) should be (e.g., sufficiently) small. However, to achieve both a large time duration and a small inter-occasion interval with the uniform time domain occasions 305, the UE 115 may perform a very large quantity of measurements. This may cause high consumption of radio resources, a low spectrum utilization ratio, and high power consumption at the UE 115.

To reduce the quantities of measurements performed by the UE 115, the UE 115 may be configured to perform measurements of a sensing signal on unevenly spaced time domain occasions 310 during the time duration 330. The unevenly spaced time domain occasions 310 may have different spacing between consecutive time domain occasions. For example, a time gap 325-c between a pair of consecutive time domain occasions of the unevenly spaced time domain occasions 310 may be different from a time gap 325-d between a second pair of consecutive time domain occasions of the unevenly spaced time domain occasions 310. As such, as the inter-occasion interval (e.g., inter-pilot interval), the total quantity of occasions (e.g., pilot quantity) may be greatly reduced for a same signal duration.

In some examples, to achieve a same (e.g., or similar) resolution for Doppler frequency estimation (e.g., speed estimation precision) as the uniform time domain occasions 305, the time duration 330 for measuring the sensing signal on the unevenly spaced time domain occasions 310 may be the same (e.g., the time between a first occasion and a last occasion for the unevenly spaced time resource assignment may be the same than for the uniform time resource assignment). As such, the UE 115 may decrease sensing signal radio resource consumption while maintaining a same or similar Doppler-domain resolution. Similarly, to maintain a same (e.g., or similar) estimation range (e.g., maximum range for speed estimation) for the Doppler frequency estimation, the minimum (e.g., a smallest) inter-occasion interval (e.g., time gap 325) for the unevenly spaced time domain occasions 310 (e.g., the unevenly spaced time resource assignment) may be a same size as the minimum inter-occasion interval for the uniform time domain occasions 305 (e.g., the uniform time domain resource assignment).

The UE 115 may use elements of an effective difference co-array (e.g., [symbol] ) calculated based on the set of unevenly spaced time domain occasions 220 as a uniform array (e.g., a ULA) for beamforming purposes. For example, as the effective difference co-array (e.g., a virtual array) may be continuous (e.g., have no “hole”), a generated beam based on the effective difference co-array may have one main lobe (e.g., no alias beam, or additional main lobes). As such, this may reduce or eliminate ambiguity in Doppler frequency estimation and speed measurements based on the set of unevenly spaced time domain occasions 220.

Accordingly, by monitoring for the sensing signal during the unevenly spaced time domain occasions 310, the UE 115 may experience reduced radio resource consumption, increased spectrum utilization ratio, and lower power consumption, while still maintaining a same or similar resolution (e.g., precision) and range for Doppler frequency estimation.

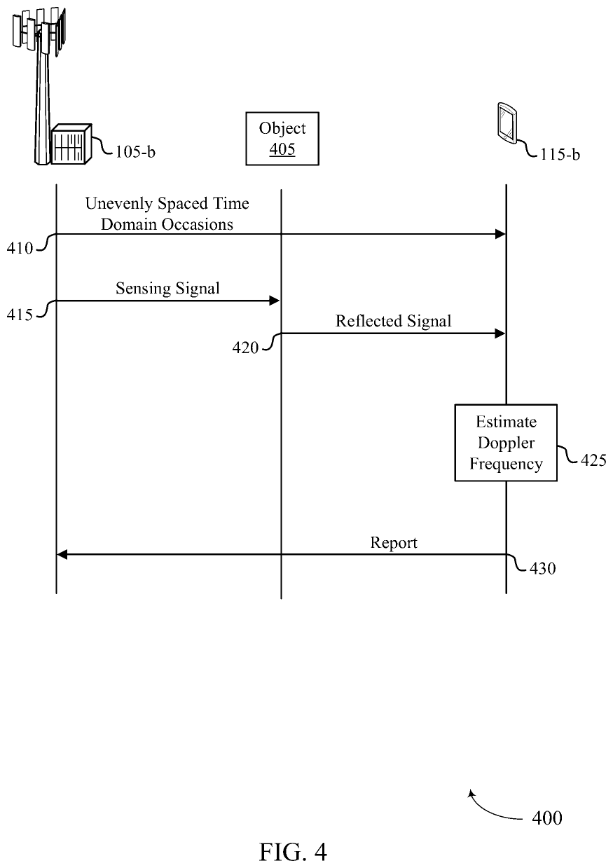

FIG. 4 shows an example of a process flow 400 that supports unevenly spaced time-domain resource assignments for sensing signals in accordance with one or more aspects of the present disclosure. The process flow 400 may depict communications between a network entity 105-b and a UE 115-b, which may be examples of corresponding components as described herein, with reference to FIGS. 1 through 3. The process flow 400 illustrates a process for estimating a speed of an object 405, which may be an example of an object 205 as described with reference to FIG. 2. In some examples, functions of the network entity 105-b may be performed by another UE 115, as described with reference to FIG. 2. In some examples, steps may be added or omitted from the process flow 400, and steps shown may be performed in different orders.

At 410, the network entity 105-b may transmit a message to configure the UE 115-b with a set of unevenly spaced time domain occasions (e.g., sparse time domain occasions) within a time duration to monitor for a sensing signal associated with estimating the speed of the object 405. In some examples, the message may indicate occasions (e.g., symbol indexes, slot indexes) of the set of unevenly spaced time domain occasions. Additionally, or alternatively, the message may indicate a sparse array formula (e.g., a nested array formula or a co-prime array formula) and one or more parameters, and the UE 115-b may formulate (e.g., generate) the set of unevenly spaced time domain occasions based on the sparse array formula and the one or more parameters. In some cases, the message may indicate a set of uniform time domain occasions, and the set of unevenly spaced time domain occasions may be a subset of the set of uniform time domain occasions.

At 415, the network entity 105-b may transmit the sensing signal. The sensing signal may be directed toward the object 405, and the object 405 may reflect the sensing signal. At 420, the UE 115-b may monitor for a reflected signal (e.g., a reflection of the sensing signal by the object 405) during the set of unevenly spaced time domain occasions.

At 425, the UE 115-b may estimate a Doppler frequency associated with the sensing signal based on monitoring for the reflected signal. In some examples, the UE 115-b may estimate the Doppler frequency based on a MUSIC-based formula or a correlation-based formula, as described herein with reference to FIG. 2. In some cases, the UE 115-b may estimate the speed of the object 405 based on the Doppler frequency.

At 430, the UE 115-b may transmit a report that indicates the estimated Doppler frequency, the estimated speed of the object 405, or both. Accordingly, the UE 115-b and the network entity 105-b may estimate the speed of the object 405 based on monitoring during unevenly spaced time domain occasions, which may reduce radio resource consumption, increase spectrum utilization ratio, and lower power consumption at the UE 115-b.

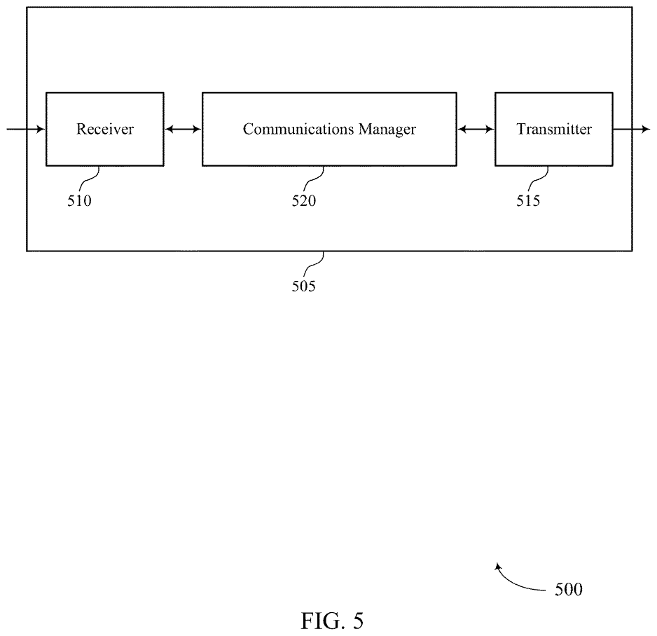

FIG. 5 shows a block diagram 500 of a device 505 that supports unevenly spaced time-domain resource assignments for sensing signals in accordance with one or more aspects of the present disclosure. The device 505 may be an example of aspects of a UE 115 as described herein. The device 505 may include a receiver 510, a transmitter 515, and a communications manager 520. The device 505 may also include one or more processors, memory coupled with the one or more processors, and instructions stored in the memory that are executable by the one or more processors to enable the one or more processors to perform the unevenly spaced-time domain resource assignment of a sensing signal as discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to unevenly spaced time-domain resource assignments for sensing signals). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to unevenly spaced time-domain resource assignments for sensing signals). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of unevenly spaced time-domain resource assignments for sensing signals as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The communications manager 520 is capable of, configured to, or operable to support a means for monitoring, within the time duration, for a first reflected sensing signal during the set of unevenly spaced time domain occasions. The communications manager 520 is capable of, configured to, or operable to support a means for transmitting a report indicating a Doppler frequency, an estimated speed of the object corresponding to the Doppler frequency, or both, based on monitoring for the first reflected sensing signal.

Additionally, or alternatively, the communications manager 520 may support wireless communications in accordance with examples as disclosed herein. For example, the communications manager 520 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The communications manager 520 is capable of, configured to, or operable to support a means for transmitting, within the time duration, a sensing signal via the set of unevenly spaced time domain occasions. The communications manager 520 is capable of, configured to, or operable to support a means for receiving a report indicating a Doppler frequency, an estimated speed of the object corresponding to the Doppler frequency, or both, based on transmitting the sensing signal.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for object speed estimation while experiencing reduced radio resource consumption, increased spectrum utilization ratio, and lowered power consumption.

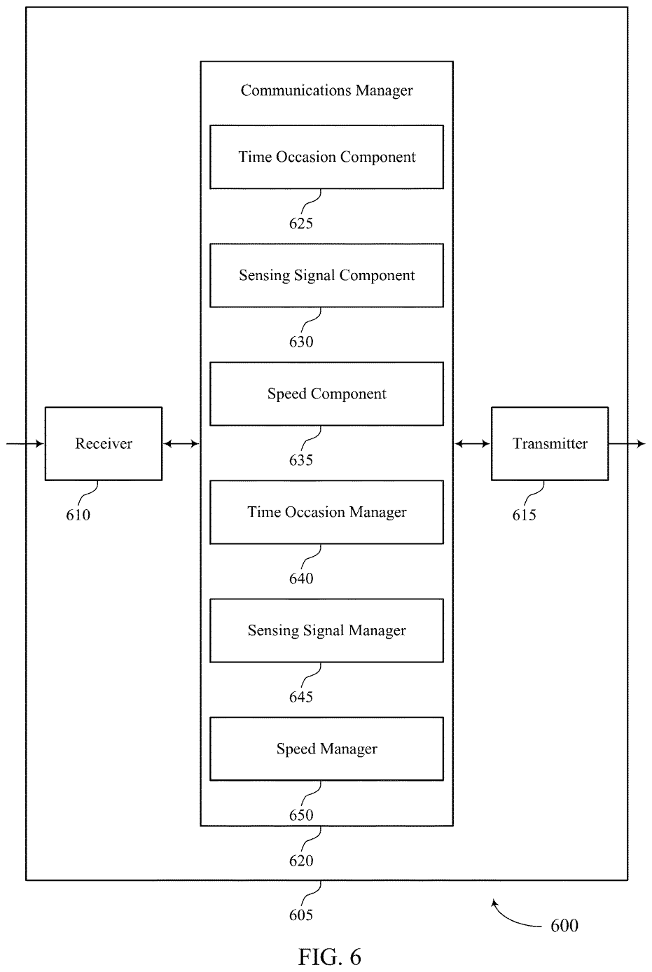

FIG. 6 shows a block diagram 600 of a device 605 that supports unevenly spaced time-domain resource assignments for sensing signals in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to unevenly spaced time-domain resource assignments for sensing signals). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to unevenly spaced time-domain resource assignments for sensing signals). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of unevenly spaced time-domain resource assignments for sensing signals as described herein. For example, the communications manager 620 may include a time occasion component 625, a sensing signal component 630, a speed component 635, a time occasion manager 640, a sensing signal manager 645, a speed manager 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The time occasion component 625 is capable of, configured to, or operable to support a means for receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The sensing signal component 630 is capable of, configured to, or operable to support a means for monitoring, within the time duration, for a first reflected sensing signal during the set of unevenly spaced time domain occasions. The speed component 635 is capable of, configured to, or operable to support a means for transmitting a report indicating a Doppler frequency, an estimated speed of the object corresponding to the Doppler frequency, or both, based on monitoring for the first reflected sensing signal.

Additionally, or alternatively, the communications manager 620 may support wireless communications in accordance with examples as disclosed herein. The time occasion manager 640 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The sensing signal manager 645 is capable of, configured to, or operable to support a means for transmitting, within the time duration, a sensing signal via the set of unevenly spaced time domain occasions. The speed manager 650 is capable of, configured to, or operable to support a means for receiving a report indicating a Doppler frequency, an estimated speed of the object corresponding to the Doppler frequency, or both, based on transmitting the sensing signal.

In some cases, the time occasion component 625, the sensing signal component 630, the speed component 635, the time occasion manager 640, the sensing signal manager 645, and the speed manager 650 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the time occasion component 625, the sensing signal component 630, the speed component 635, the time occasion manager 640, the sensing signal manager 645, and the speed manager 650 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

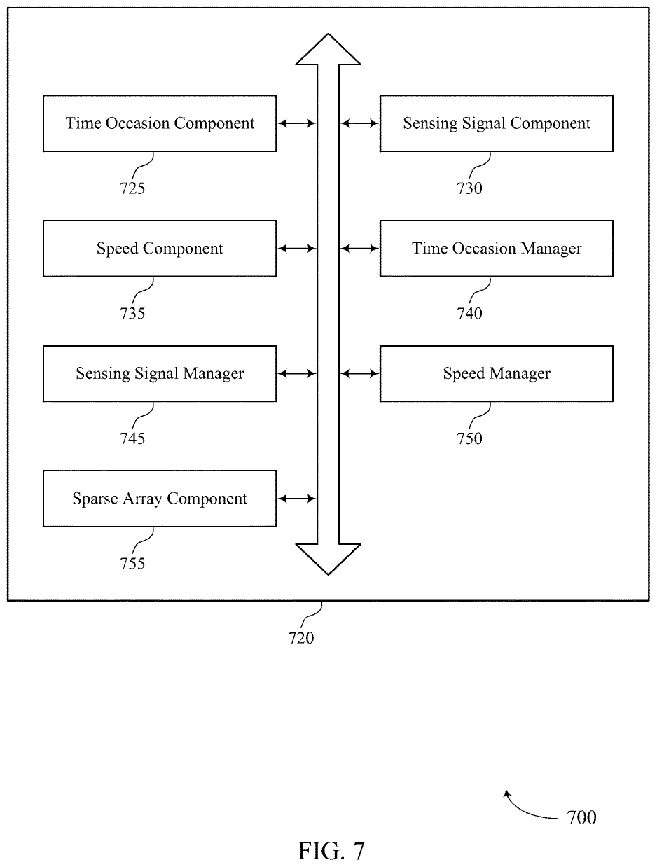

FIG. 7 shows a block diagram 700 of a communications manager 720 that supports unevenly spaced time-domain resource assignments for sensing signals in accordance with one or more aspects of the present disclosure. The communications manager 720 may be an example of aspects of a communications manager 520, a communications manager 620, or both, as described herein. The communications manager 720, or various components thereof, may be an example of means for performing various aspects of unevenly spaced time-domain resource assignments for sensing signals as described herein. For example, the communications manager 720 may include a time occasion component 725, a sensing signal component 730, a speed component 735, a time occasion manager 740, a sensing signal manager 745, a speed manager 750, a sparse array component 755, or any combination thereof. Each of these components may communicate, directly or indirectly, with one another (e.g., via one or more buses).

The communications manager 720 may support wireless communications in accordance with examples as disclosed herein. The time occasion component 725 is capable of, configured to, or operable to support a means for receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The sensing signal component 730 is capable of, configured to, or operable to support a means for monitoring, within the time duration, for a first reflected sensing signal during the set of unevenly spaced time domain occasions. The speed component 735 is capable of, configured to, or operable to support a means for transmitting a report indicating a Doppler frequency, an estimated speed of the object corresponding to the Doppler frequency, or both, based on monitoring for the first reflected sensing signal.

In some examples, the sensing signal component 730 is capable of, configured to, or operable to support a means for monitoring, within the time duration, for a second reflected sensing signal associated with estimating a speed of a second object during the set of unevenly spaced time domain occasions, where the report indicates a second Doppler frequency, an estimated speed of the second object corresponding to the second Doppler frequency, or both, based on the second reflected sensing signal.

In some examples, to support receiving the control signaling, the time occasion component 725 is capable of, configured to, or operable to support a means for receiving the control signaling indicating an index identifying a position within the time duration for each time domain occasion of the set of unevenly spaced time domain occasions.

In some examples, to support receiving the control signaling, the time occasion component 725 is capable of, configured to, or operable to support a means for receiving the control signaling indicating that a time gap between any pair of consecutive time domain occasions of the set of unevenly spaced time domain occasions is different than a time gap between any other pair of consecutive time domain occasions of the set of unevenly spaced time domain occasions.

In some examples, to support monitoring, the sparse array component 755 is capable of, configured to, or operable to support a means for monitoring, within the time duration, for the first reflected sensing signal during the set of unevenly spaced time domain occasions based on the sparse array formula and the one or more parameters, where a first subset of the set of unevenly spaced time domain occasions includes a subset of time domain occasions of a first uniform array, and a second subset of the set of unevenly spaced time domain occasions includes a subset of time domain occasions of a second uniform array.

In some examples, the sparse array formula includes a nested array formula and the one or more parameters include a quantity of elements associated with the set of unevenly spaced time domain occasions. In some examples, the sparse array formula includes a co-prime array formula and the one or more parameters include a pair of co-prime integers.

In some examples, the control signaling indicates a set of uniform time domain occasions, and the time occasion component 725 is capable of, configured to, or operable to support a means for receiving a control message indicating to monitor the sensing signal during the set of unevenly spaced time domain occasions.

In some examples, the set of unevenly spaced time domain occasions includes a subset of the set of uniform time domain occasions. In some examples, the subset of the set of uniform time domain occasions is based on a sparse array formula, one or more parameters, and a maximum quantity for generation of a sparse array that has a latest time domain occasion of the set of unevenly spaced time domain occasions that occurs within a time duration of a uniform array.

In some examples, the control signaling indicates a set of uniform time domain occasions, and the time occasion component 725 is capable of, configured to, or operable to support a means for receiving a control message indicating to monitor the sensing signal during the set of uniform time domain occasions.

In some examples, the speed component 735 is capable of, configured to, or operable to support a means for calculating the Doppler frequency based on a time-domain channel covariance matrix associated with the first reflected sensing signal. In some examples, calculating the Doppler frequency is based on obtaining a difference co-array domain channel covariance matrix associated with the first reflected sensing signal. In some examples, calculating the Doppler frequency is based on obtaining a difference co-array domain channel response vector associated with the first reflected sensing signal.

In some examples, the control signaling includes radio resource control signaling that indicates a periodic sensing signal configuration identifying the set of unevenly spaced time domain occasions. In some examples, the control signaling includes a MAC-CE message or a downlink control information message that indicates an aperiodic sensing signal configuration identifying the set of unevenly spaced time domain occasions.

Additionally, or alternatively, the communications manager 720 may support wireless communications in accordance with examples as disclosed herein. The time occasion manager 740 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The sensing signal manager 745 is capable of, configured to, or operable to support a means for transmitting, within the time duration, a sensing signal via the set of unevenly spaced time domain occasions. The speed manager 750 is capable of, configured to, or operable to support a means for receiving a report indicating a Doppler frequency, an estimated speed of the object corresponding to the Doppler frequency, or both, based on transmitting the sensing signal. In some examples, the report indicates a second Doppler frequency, an estimated speed of a second object corresponding to the second Doppler frequency, or both.

In some examples, to support transmitting the control signaling, the time occasion manager 740 is capable of, configured to, or operable to support a means for transmitting the control signaling indicating an index identifying a position within the time duration for each time domain occasion of the set of unevenly spaced time domain occasions.

In some examples, to support transmitting the control signaling, the time occasion manager 740 is capable of, configured to, or operable to support a means for transmitting the control signaling indicating that a time gap between any pair of consecutive time domain occasions of the set of unevenly spaced time domain occasions is different than a time gap between any other pair of consecutive time domain occasions of the set of unevenly spaced time domain occasions.

In some examples, the control signaling indicates a sparse array formula and one or more parameters, and a first subset of the set of unevenly spaced time domain occasions includes a subset of time domain occasions of a first uniform array, and a second subset of the set of unevenly spaced time domain occasions includes a subset of time domain occasions of a second uniform array.

In some examples, the sparse array formula includes a nested array formula and the one or more parameters include a quantity of elements associated with the set of unevenly spaced time domain occasions. In some examples, the sparse array formula includes a co-prime array formula and the one or more parameters include a pair of co-prime integers.

In some examples, the control signaling indicates a set of uniform time domain occasions, and the time occasion manager 740 is capable of, configured to, or operable to support a means for transmitting a control message indicating to monitor the sensing signal during the set of unevenly spaced time domain occasions. In some examples, the set of unevenly spaced time domain occasions includes a subset of the set of uniform time domain occasions.

In some examples, the subset of the set of uniform time domain occasions is based on a sparse array formula, one or more parameters, and a maximum quantity for generation of a sparse array that has a latest time domain occasion of the set of unevenly spaced time domain occasions that occurs within a time duration of a uniform array.

In some examples, the control signaling indicates a set of uniform time domain occasions, and the time occasion manager 740 is capable of, configured to, or operable to support a means for transmitting a control message indicating to monitor the sensing signal during the set of uniform time domain occasions.

In some examples, the control signaling includes radio resource control signaling that indicates a periodic sensing signal configuration identifying the set of unevenly spaced time domain occasions.

In some examples, the control signaling includes a MAC-CE message or a downlink control information message that indicates an aperiodic sensing signal configuration identifying the set of unevenly spaced time domain occasions.

In some cases, the time occasion component 725, the sensing signal component 730, the speed component 735, the time occasion manager 740, the sensing signal manager 745, the speed manager 750, and the sparse array component 755 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the time occasion component 725, the sensing signal component 730, the speed component 735, the time occasion manager 740, the sensing signal manager 745, the speed manager 750, and the sparse array component 755 discussed herein.

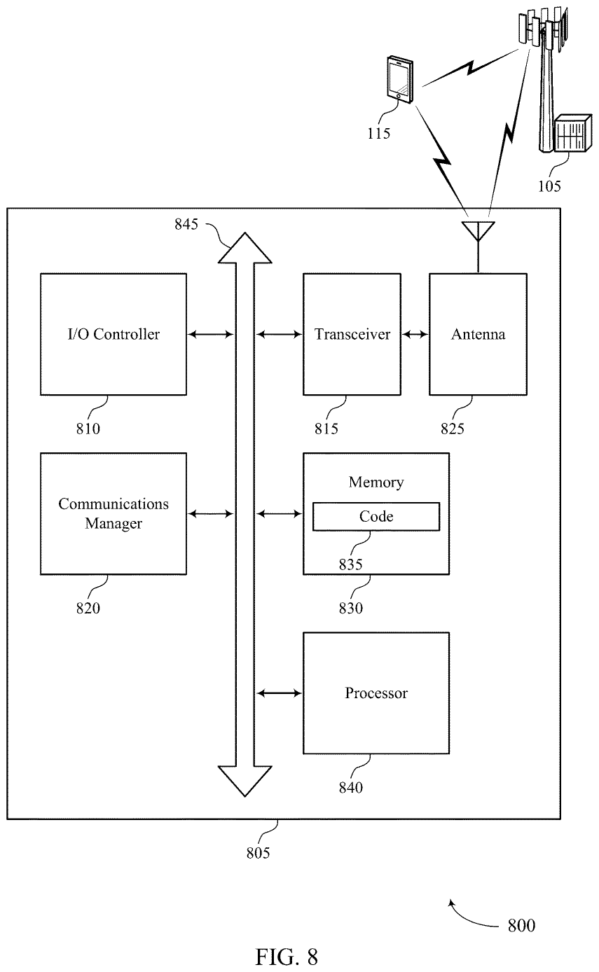

FIG. 8 shows a diagram of a system 800 including a device 805 that supports unevenly spaced time-domain resource assignments for sensing signals in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting unevenly spaced time-domain resource assignments for sensing signals). For example, the device 805 or a component of the device 805 may include a processor 840 and memory 830 coupled with or to the processor 840, the processor 840 and memory 830 configured to perform various functions described herein.

The communications manager 820 may support wireless communications in accordance with examples as disclosed herein. For example, the communications manager 820 is capable of, configured to, or operable to support a means for receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The communications manager 820 is capable of, configured to, or operable to support a means for monitoring, within the time duration, for a first reflected sensing signal during the set of unevenly spaced time domain occasions. The communications manager 820 is capable of, configured to, or operable to support a means for transmitting a report indicating a Doppler frequency, an estimated speed of the object corresponding to the Doppler frequency, or both, based on monitoring for the first reflected sensing signal.

Additionally, or alternatively, the communications manager 820 may support wireless communications in accordance with examples as disclosed herein. For example, the communications manager 820 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The communications manager 820 is capable of, configured to, or operable to support a means for transmitting, within the time duration, a sensing signal via the set of unevenly spaced time domain occasions. The communications manager 820 is capable of, configured to, or operable to support a means for receiving a report indicating a Doppler frequency, an estimated speed of the object corresponding to the Doppler frequency, or both, based on transmitting the sensing signal.

By including or configuring the communications manager 820 in accordance with examples as described herein, the device 805 may support techniques for object speed estimation while experiencing reduced radio resource consumption, increased spectrum utilization ratio, and lowered power consumption.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of unevenly spaced time-domain resource assignments for sensing signals as described herein, or the processor 840 and the memory 830 may be otherwise configured to perform or support such operations.

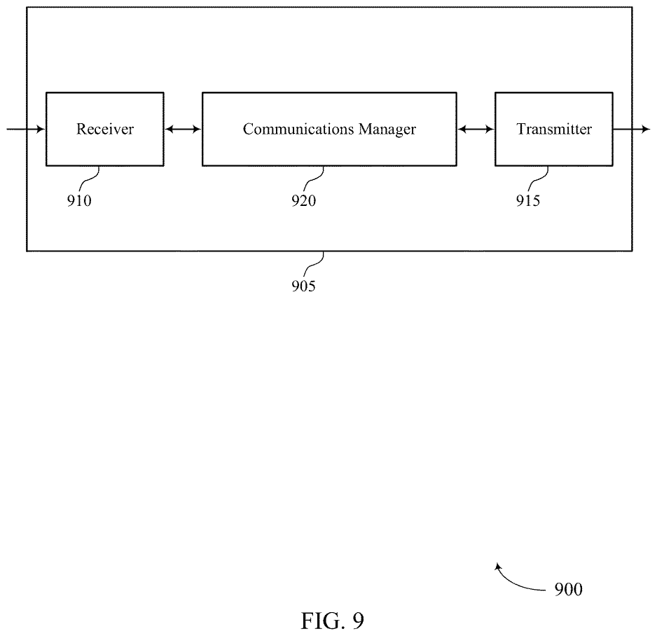

FIG. 9 shows a block diagram 900 of a device 905 that supports unevenly spaced time-domain resource assignments for sensing signals in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of unevenly spaced time-domain resource assignments for sensing signals as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The communications manager 920 is capable of, configured to, or operable to support a means for transmitting, within the time duration, a sensing signal via the set of unevenly spaced time domain occasions. The communications manager 920 is capable of, configured to, or operable to support a means for receiving a report indicating a Doppler frequency, an estimated speed of the object corresponding to the Doppler frequency, or both, based on transmitting the sensing signal.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for object speed estimation while experiencing reduced radio resource consumption, increased spectrum utilization ratio, and lowered power consumption.

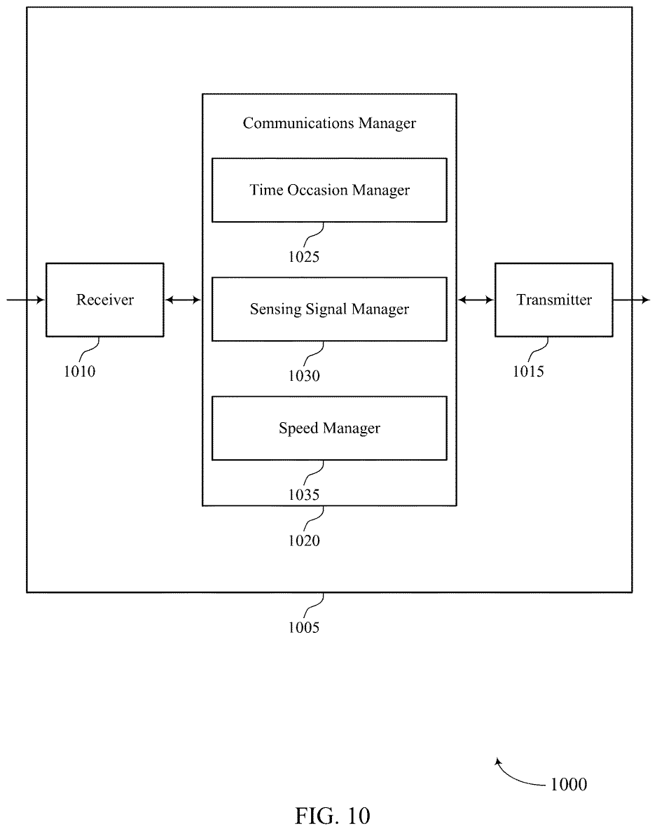

FIG. 10 shows a block diagram 1000 of a device 1005 that supports unevenly spaced time-domain resource assignments for sensing signals in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of unevenly spaced time-domain resource assignments for sensing signals as described herein. For example, the communications manager 1020 may include a time occasion manager 1025, a sensing signal manager 1030, a speed manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The time occasion manager 1025 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The sensing signal manager 1030 is capable of, configured to, or operable to support a means for transmitting, within the time duration, a sensing signal via the set of unevenly spaced time domain occasions. The speed manager 1035 is capable of, configured to, or operable to support a means for receiving a report indicating a Doppler frequency, an estimated speed of the object corresponding to the Doppler frequency, or both, based on transmitting the sensing signal.

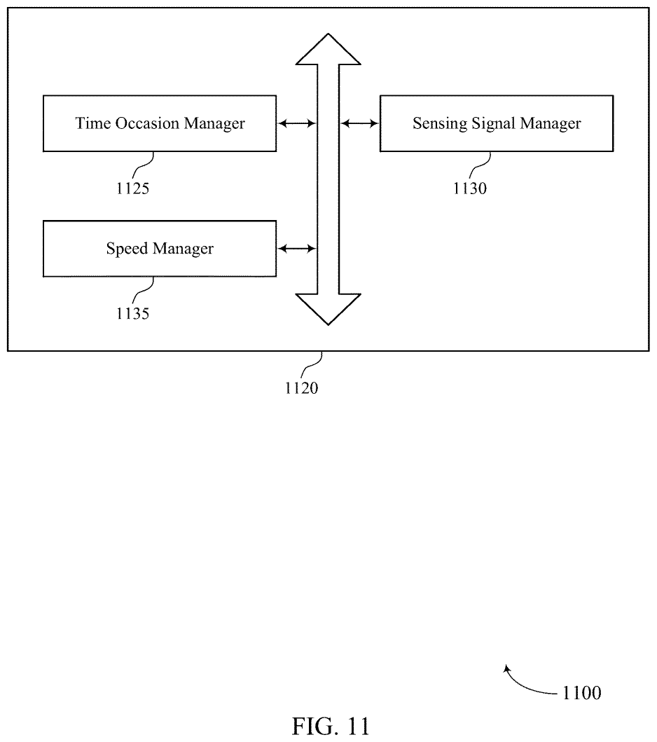

FIG. 11 shows a block diagram 1100 of a communications manager 1120 that supports unevenly spaced time-domain resource assignments for sensing signals in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of unevenly spaced time-domain resource assignments for sensing signals as described herein. For example, the communications manager 1120 may include a time occasion manager 1125, a sensing signal manager 1130, a speed manager 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The time occasion manager 1125 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The sensing signal manager 1130 is capable of, configured to, or operable to support a means for transmitting, within the time duration, a sensing signal via the set of unevenly spaced time domain occasions. The speed manager 1135 is capable of, configured to, or operable to support a means for receiving a report indicating a Doppler frequency, an estimated speed of the object corresponding to the Doppler frequency, or both, based on transmitting the sensing signal.

In some examples, the report indicates a second Doppler frequency, an estimated speed of a second object corresponding to the second Doppler frequency, or both.

In some examples, to support transmitting the control signaling, the time occasion manager 1125 is capable of, configured to, or operable to support a means for transmitting the control signaling indicating an index identifying a position within the time duration for each time domain occasion of the set of unevenly spaced time domain occasions.

In some examples, to support transmitting the control signaling, the time occasion manager 1125 is capable of, configured to, or operable to support a means for transmitting the control signaling indicating that a time gap between any pair of consecutive time domain occasions of the set of unevenly spaced time domain occasions is different than a time gap between any other pair of consecutive time domain occasions of the set of unevenly spaced time domain occasions.

In some examples, the control signaling indicates a sparse array formula and one or more parameters, and a first subset of the set of unevenly spaced time domain occasions includes a subset of time domain occasions of a first uniform array, and a second subset of the set of unevenly spaced time domain occasions includes a subset of time domain occasions of a second uniform array.

In some examples, the sparse array formula includes a nested array formula and the one or more parameters include a quantity of elements associated with the set of unevenly spaced time domain occasions.

In some examples, the sparse array formula includes a co-prime array formula and the one or more parameters include a pair of co-prime integers.

In some examples, the control signaling indicates a set of uniform time domain occasions, and the time occasion manager 1125 is capable of, configured to, or operable to support a means for transmitting a control message indicating to monitor the sensing signal during the set of unevenly spaced time domain occasions.

In some examples, the set of unevenly spaced time domain occasions includes a subset of the set of uniform time domain occasions.

In some examples, the subset of the set of uniform time domain occasions is based on a sparse array formula, one or more parameters, and a maximum quantity for generation of a sparse array that has a latest time domain occasion of the set of unevenly spaced time domain occasions that occurs within a time duration of a uniform array.

In some examples, the control signaling indicates a set of uniform time domain occasions, and the time occasion manager 1125 is capable of, configured to, or operable to support a means for transmitting a control message indicating to monitor the sensing signal during the set of uniform time domain occasions.

In some examples, the control signaling includes radio resource control signaling that indicates a periodic sensing signal configuration identifying the set of unevenly spaced time domain occasions. In some examples, the control signaling includes a MAC-CE message or a downlink control information message that indicates an aperiodic sensing signal configuration identifying the set of unevenly spaced time domain occasions.

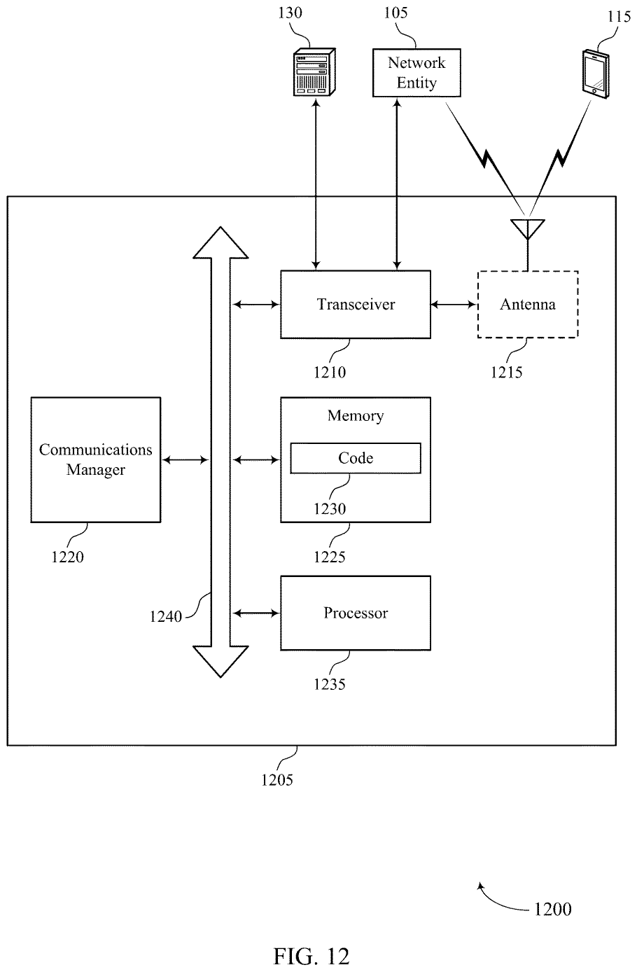

FIG. 12 shows a diagram of a system 1200 including a device 1205 that supports unevenly spaced time-domain resource assignments for sensing signals in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting unevenly spaced time-domain resource assignments for sensing signals). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The communications manager 1220 is capable of, configured to, or operable to support a means for transmitting, within the time duration, a sensing signal via the set of unevenly spaced time domain occasions. The communications manager 1220 is capable of, configured to, or operable to support a means for receiving a report indicating a Doppler frequency, an estimated speed of the object corresponding to the Doppler frequency, or both, based on transmitting the sensing signal.

By including or configuring the communications manager 1220 in accordance with examples as described herein, the device 1205 may support techniques for object speed estimation while experiencing reduced radio resource consumption, increased spectrum utilization ratio, and lowered power consumption.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of unevenly spaced time-domain resource assignments for sensing signals as described herein, or the processor 1235 and the memory 1225 may be otherwise configured to perform or support such operations.

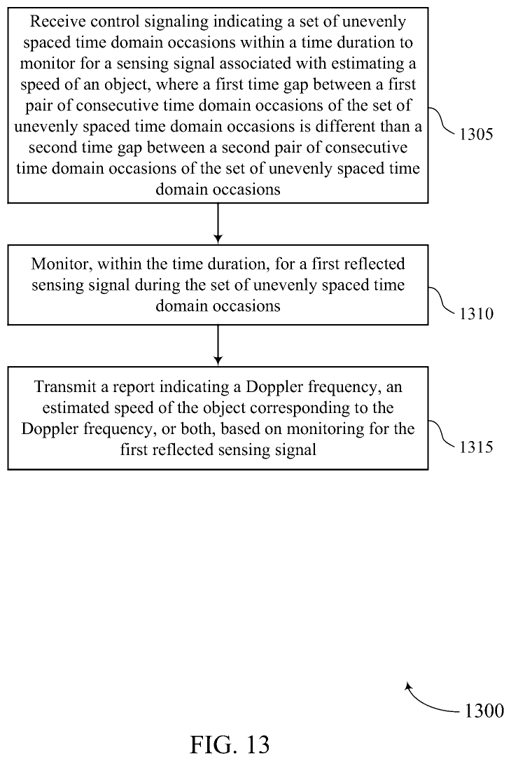

FIG. 13 shows a flowchart illustrating a method 1300 that supports unevenly spaced time-domain resource assignments for sensing signals in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The operations of block 1305 may be performed in accordance with examples as disclosed herein. In some examples, aspects of the operations of 1305 may be performed by a time occasion component 725 as described with reference to FIG. 7.

At 1310, the method may include monitoring, within the time duration, for a first reflected sensing signal during the set of unevenly spaced time domain occasions. The operations of block 1310 may be performed in accordance with examples as disclosed herein. In some examples, aspects of the operations of 1310 may be performed by a sensing signal component 730 as described with reference to FIG. 7.

At 1315, the method may include transmitting a report indicating a Doppler frequency, an estimated speed of the object corresponding to the Doppler frequency, or both, based on monitoring for the first reflected sensing signal. The operations of block 1315 may be performed in accordance with examples as disclosed herein. In some examples, aspects of the operations of 1315 may be performed by a speed component 735 as described with reference to FIG. 7.

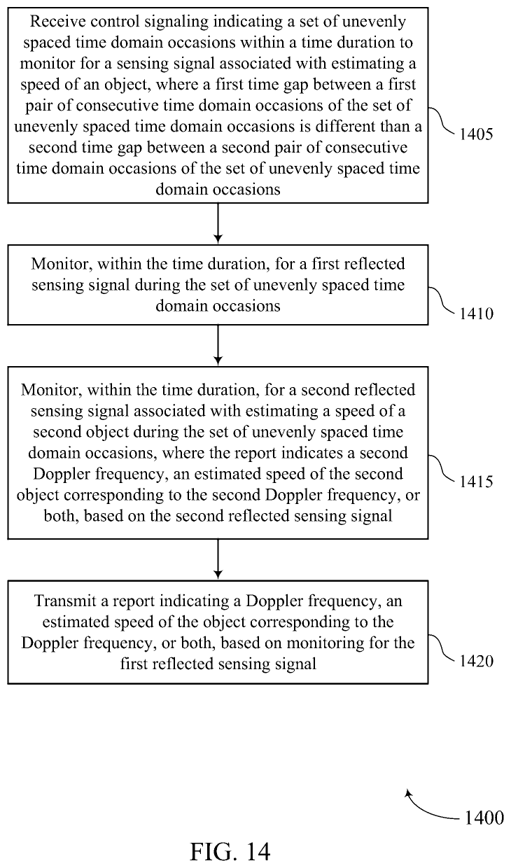

FIG. 14 shows a flowchart illustrating a method 1400 that supports unevenly spaced time-domain resource assignments for sensing signals in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The operations of block 1405 may be performed in accordance with examples as disclosed herein. In some examples, aspects of the operations of 1405 may be performed by a time occasion component 725 as described with reference to FIG. 7.

At 1410, the method may include monitoring, within the time duration, for a first reflected sensing signal during the set of unevenly spaced time domain occasions. The operations of block 1410 may be performed in accordance with examples as disclosed herein. In some examples, aspects of the operations of 1410 may be performed by a sensing signal component 730 as described with reference to FIG. 7.

At 1415, the method may include monitoring, within the time duration, for a second reflected sensing signal associated with estimating a speed of a second object during the set of unevenly spaced time domain occasions, where the report indicates a second Doppler frequency, an estimated speed of the second object corresponding to the second Doppler frequency, or both, based on the second reflected sensing signal. The operations of block 1415 may be performed in accordance with examples as disclosed herein. In some examples, aspects of the operations of 1415 may be performed by a sensing signal component 730 as described with reference to FIG. 7.

At 1420, the method may include transmitting a report indicating a Doppler frequency, an estimated speed of the object corresponding to the Doppler frequency, or both, based on monitoring for the first reflected sensing signal. The operations of block 1420 may be performed in accordance with examples as disclosed herein. In some examples, aspects of the operations of 1420 may be performed by a speed component 735 as described with reference to FIG. 7.

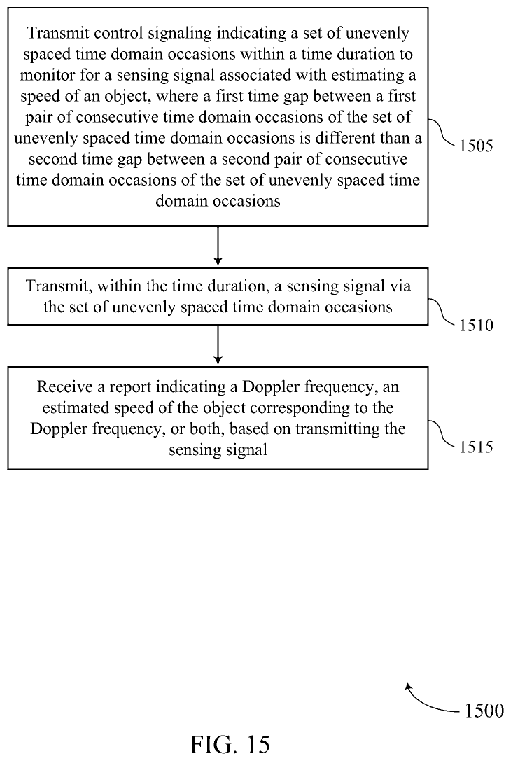

FIG. 15 shows a flowchart illustrating a method 1500 that supports unevenly spaced time-domain resource assignments for sensing signals in accordance with aspects of the present disclosure. The operations of the method 1500 may be implemented by a UE or a network entity or its components as described herein. For example, the operations of the method 1500 may be performed by a UE 115 as described with reference to FIGS. 1 through 8 or a network entity as described with reference to FIGS. 1 through 4 and 9 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include transmitting control signaling indicating a set of unevenly spaced time domain occasions within a time duration to monitor for a sensing signal associated with estimating a speed of an object, where a first time gap between a first pair of consecutive time domain occasions of the set of unevenly spaced time domain occasions is different than a second time gap between a second pair of consecutive time domain occasions of the set of unevenly spaced time domain occasions. The operations of block 1505 may be performed in accordance with examples as disclosed herein. In some examples, aspects of the operations of 1505 may be performed by a time occasion manager 740 or a time occasion manager 1125 as described with reference to FIGS. 7 and 11.

At 1510, the method may include transmitting, within the time duration, a sensing signal via the set of unevenly spaced time domain occasions. The operations of block 1510 may be performed in accordance with examples as disclosed herein. In some examples, aspects of the operations of 1510 may be performed by a sensing signal manager 745 or a sensing signal manager 1130 as described with reference to FIGS. 7 and 11.

At 1515, the method may include receiving a report indicating a Doppler frequency, an estimated speed of the object corresponding to the Doppler frequency, or both, based on transmitting the sensing signal. The operations of block 1515 may be performed in accordance with examples as disclosed herein. In some examples, aspects of the operations of 1515 may be performed by a speed manager 750 or a speed manager 1135 as described with reference to FIGS. 7 and 11.

The following provides an overview of aspects of the present disclosure:

Aspect 1: A method for wireless communications by a UE, comprising: receiving control signaling indicating a set of unevenly spaced time domain occasions within a time duration to monitor for a sensing signal associated with estimating a speed of an object, wherein a first time gap between a first pair of consecutive time domain occasions of the set of unevenly spaced time domain occasions is different than a second time gap between a second pair of consecutive time domain occasions of the set of unevenly spaced time domain occasions; monitoring, within the time duration, for a first reflected sensing signal during the set of unevenly spaced time domain occasions; and transmitting a report indicating a Doppler frequency, an estimated speed of the object corresponding to the Doppler frequency, or both, based at least in part on monitoring for the first reflected sensing signal.

Aspect 2: The method of aspect 1, further comprising: monitoring, within the time duration, for a second reflected sensing signal associated with estimating a speed of a second object during the set of unevenly spaced time domain occasions, wherein the report indicates a second Doppler frequency, an estimated speed of the second object corresponding to the second Doppler frequency, or both, based at least in part on the second reflected sensing signal.

Aspect 3: The method of any of aspects 1 through 2, wherein receiving the control signaling comprises: receiving the control signaling indicating an index identifying a position within the time duration for each time domain occasion of the set of unevenly spaced time domain occasions.

Aspect 4: The method of aspect 3, wherein receiving the control signaling comprises: receiving the control signaling indicating that a time gap between any pair of consecutive time domain occasions of the set of unevenly spaced time domain occasions is different than a time gap between any other pair of consecutive time domain occasions of the set of unevenly spaced time domain occasions.

Aspect 5: The method of any of aspects 1 through 4, wherein the control signaling indicates a sparse array formula and one or more parameters, and wherein the monitoring further comprises: monitoring, within the time duration, for the first reflected sensing signal during the set of unevenly spaced time domain occasions based at least in part on the sparse array formula and the one or more parameters, wherein a first subset of the set of unevenly spaced time domain occasions comprises a subset of time domain occasions of a first uniform array, and a second subset of the set of unevenly spaced time domain occasions comprises a subset of time domain occasions of a second uniform array.

Aspect 6: The method of aspect 5, wherein the sparse array formula comprises a nested array formula and the one or more parameters comprise a quantity of elements associated with the set of unevenly spaced time domain occasions.

Aspect 7: The method of aspect 5, wherein the sparse array formula comprises a co-prime array formula and the one or more parameters comprise a pair of co-prime integers.

Aspect 8: The method of any of aspects 1 through 7, wherein the control signaling indicates a set of uniform time domain occasions, the method further comprising: receiving a control message indicating to monitor the sensing signal during the set of unevenly spaced time domain occasions.

Aspect 9: The method of aspect 8, wherein the set of unevenly spaced time domain occasions comprises a subset of the set of uniform time domain occasions.

Aspect 10: The method of aspect 9, wherein the subset of the set of uniform time domain occasions is based at least in part on a sparse array formula, one or more parameters, and a maximum quantity for generation of a sparse array that has a latest time domain occasion of the set of unevenly spaced time domain occasions that occurs within a time duration of a uniform array.

Aspect 11: The method of any of aspects 1 through 10, wherein the control signaling indicates a set of uniform time domain occasions, the method further comprising: receiving a control message indicating to monitor the sensing signal during the set of uniform time domain occasions.

Aspect 12: The method of any of aspects 1 through 11, further comprising: calculating the Doppler frequency based at least in part on a time-domain channel covariance matrix associated with the first reflected sensing signal.

Aspect 13: The method of aspect 12, wherein calculating the Doppler frequency is based at least in part on obtaining a difference co-array-domain channel covariance matrix associated with the first reflected sensing signal.

Aspect 14: The method of any of aspects 12 through 13, wherein calculating the Doppler frequency is based at least in part on obtaining a difference co-array-domain channel response vector associated with the first reflected sensing signal.

Aspect 15: The method of any of aspects 1 through 14, wherein the control signaling comprises radio resource control signaling that indicates a periodic sensing signal configuration identifying the set of unevenly spaced time domain occasions.

Aspect 16: The method of any of aspects 1 through 15, wherein the control signaling comprises a MAC-CE message or a downlink control information message that indicates an aperiodic sensing signal configuration identifying the set of unevenly spaced time domain occasions.

Aspect 17: A method for wireless communications by a wireless communication device, comprising: transmitting control signaling indicating a set of unevenly spaced time domain occasions within a time duration to monitor for a sensing signal associated with estimating a speed of an object, wherein a first time gap between a first pair of consecutive time domain occasions of the set of unevenly spaced time domain occasions is different than a second time gap between a second pair of consecutive time domain occasions of the set of unevenly spaced time domain occasions; transmitting, within the time duration, a sensing signal via the set of unevenly spaced time domain occasions; and receiving a report indicating a Doppler frequency, an estimated speed of the object corresponding to the Doppler frequency, or both, based at least in part on transmitting the sensing signal.

Aspect 18: The method of aspect 17, wherein the report indicates a second Doppler frequency, an estimated speed of a second object corresponding to the second Doppler frequency, or both.

Aspect 19: The method of any of aspects 17 through 18, wherein transmitting the control signaling comprises: transmitting the control signaling indicating an index identifying a position within the time duration for each time domain occasion of the set of unevenly spaced time domain occasions.

Aspect 20: The method of aspect 19, wherein transmitting the control signaling comprises: transmitting the control signaling indicating that a time gap between any pair of consecutive time domain occasions of the set of unevenly spaced time domain occasions is different than a time gap between any other pair of consecutive time domain occasions of the set of unevenly spaced time domain occasions.

Aspect 21: The method of any of aspects 17 through 20, wherein the control signaling indicates a sparse array formula and one or more parameters, and a first subset of the set of unevenly spaced time domain occasions comprises a subset of time domain occasions of a first uniform array, and a second subset of the set of unevenly spaced time domain occasions comprises a subset of time domain occasions of a second uniform array.

Aspect 22: The method of aspect 21, wherein the sparse array formula comprises a nested array formula and the one or more parameters comprise a quantity of elements associated with the set of unevenly spaced time domain occasions.

Aspect 23: The method of aspect 21, wherein the sparse array formula comprises a co-prime array formula and the one or more parameters comprise a pair of co-prime integers.

Aspect 24: The method of any of aspects 17 through 23, wherein the control signaling indicates a set of uniform time domain occasions, the method further comprising: transmitting a control message indicating to monitor the sensing signal during the set of unevenly spaced time domain occasions.

Aspect 25: The method of aspect 24, wherein the set of unevenly spaced time domain occasions comprises a subset of the set of uniform time domain occasions.

Aspect 26: The method of aspect 25, wherein the subset of the set of uniform time domain occasions is based at least in part on a sparse array formula, one or more parameters, and a maximum quantity for generation of a sparse array that has a latest time domain occasion of the set of unevenly spaced time domain occasions that occurs within a time duration of a uniform array.

Aspect 27: The method of any of aspects 17 through 26, wherein the control signaling indicates a set of uniform time domain occasions, the method further comprising: transmitting a control message indicating to monitor the sensing signal during the set of uniform time domain occasions.

Aspect 28: The method of any of aspects 17 through 27, wherein the control signaling comprises radio resource control signaling that indicates a periodic sensing signal configuration identifying the set of unevenly spaced time domain occasions.

Aspect 29: The method of any of aspects 17 through 28, wherein the control signaling comprises a MAC-CE message or a downlink control information message that indicates an aperiodic sensing signal configuration identifying the set of unevenly spaced time domain occasions.

Aspect 30: A UE for wireless communications, comprising one or more processors; one or more memories coupled with the one or more processors; and instructions stored in the one or more memories and executable by the one or more processors to cause the apparatus to perform a method of any of aspects 1 through 16.

Aspect 31: A UE for wireless communications, comprising at least one means for performing a method of any of aspects 1 through 16.

Aspect 32: A non-transitory computer-readable medium storing code for wireless communications by a UE, the code comprising instructions executable by a processor to perform a method of any of aspects 1 through 16.

Aspect 33: A wireless communication device for wireless communications, comprising one or more processors; one or more memories coupled with the one or more processors; and instructions stored in the one or more memories and executable by the one or more processors to cause the apparatus to perform a method of any of aspects 17 through 29.

Aspect 34: An wireless communication device for wireless communications, comprising at least one means for performing a method of any of aspects 17 through 29.

Aspect 35: A non-transitory computer-readable medium storing code for wireless communications by a wireless communication device, the code comprising instructions executable by a processor to perform a method of any of aspects 17 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communications, comprising:
one or more memories; and
one or more processors coupled with the one or more memories and configured to cause the UE to:
receive control signaling indicating a set of unevenly spaced time domain occasions within a time duration to monitor for a sensing signal associated with estimating a speed of an object, wherein a first time gap between a first pair of consecutive time domain occasions of the set of unevenly spaced time domain occasions is different than a second time gap between a second pair of consecutive time domain occasions of the set of unevenly spaced time domain occasions;
monitor, within the time duration, for a first reflected sensing signal during the set of unevenly spaced time domain occasions; and
transmit a report indicating a Doppler frequency, an estimated speed of the object corresponding to the Doppler frequency, or both, based at least in part on monitoring for the first reflected sensing signal.

2. The UE of claim 1, wherein the one or more processors are further configured to cause the UE to:
monitor, within the time duration, for a second reflected sensing signal associated with estimating a speed of a second object during the set of unevenly spaced time domain occasions, wherein the report indicates a second Doppler frequency, an estimated speed of the second object corresponding to the second Doppler frequency, or both, based at least in part on the second reflected sensing signal.

3. The UE of claim 1, wherein, to receive the control signaling, the one or more processors are configured to cause the UE to:
receive the control signaling indicating an index identifying a position within the time duration for each time domain occasion of the set of unevenly spaced time domain occasions.

4. The UE of claim 3, wherein, to receive the control signaling, the one or more processors are configured to cause the UE to:
receive the control signaling indicating that a time gap between any pair of consecutive time domain occasions of the set of unevenly spaced time domain occasions is different than a time gap between any other pair of consecutive time domain occasions of the set of unevenly spaced time domain occasions.

5. The UE of claim 1, wherein, to monitor for the first reflected sensing signal, the one or more processors are further configured to cause the UE to:
monitor, within the time duration, for the first reflected sensing signal during the set of unevenly spaced time domain occasions based at least in part on a sparse array formula and one or more parameters, wherein a first subset of the set of unevenly spaced time domain occasions comprises a subset of time domain occasions of a first uniform array, and a second subset of the set of unevenly spaced time domain occasions comprises a subset of time domain occasions of a second uniform array.

6. The UE of claim 5, wherein the sparse array formula comprises a nested array formula and the one or more parameters comprise a quantity of elements associated with the set of unevenly spaced time domain occasions.

7. The UE of claim 5, wherein the sparse array formula comprises a co-prime array formula and the one or more parameters comprise a pair of co-prime integers.

8. The UE of claim 1, wherein the control signaling indicates a set of uniform time domain occasions, and the one or more processors are further configured to cause the UE to:
receive a control message indicating to monitor the sensing signal during the set of unevenly spaced time domain occasions.

9. The UE of claim 8, wherein the set of unevenly spaced time domain occasions comprises a subset of the set of uniform time domain occasions.

10. The UE of claim 9, wherein the subset of the set of uniform time domain occasions is based at least in part on a sparse array formula, one or more parameters, and a maximum quantity for generation of a sparse array that has a latest time domain occasion of the set of unevenly spaced time domain occasions that occurs within a time duration of a uniform array.

11. The UE of claim 1, wherein the control signaling indicates a set of uniform time domain occasions, and the one or more processors are further configured to cause the UE to:
receive a control message indicating to monitor the sensing signal during the set of uniform time domain occasions.

12. The UE of claim 1, wherein the one or more processors are further configured to cause the UE to:
calculate the Doppler frequency based at least in part on a time domain channel covariance matrix associated with the first reflected sensing signal.

13. The UE of claim 12, wherein calculating the Doppler frequency is based at least in part on obtaining a difference co-array domain channel covariance matrix associated with the first reflected sensing signal.

14. The UE of claim 12, wherein calculating the Doppler frequency is based at least in part on obtaining a difference co-array domain channel response vector associated with the first reflected sensing signal.

15. The UE of claim 1, wherein the control signaling comprises radio resource control signaling that indicates a periodic sensing signal configuration identifying the set of unevenly spaced time domain occasions.

16. The UE of claim 1, wherein the control signaling comprises a medium access control-control element (MAC-CE) message or a downlink control information message that indicates an aperiodic sensing signal configuration identifying the set of unevenly spaced time domain occasions.

17. A wireless communication device for wireless communications, comprising:
one or more memories; and
one or more processors coupled with the one or more memories and configured to cause the wireless communication device to:
transmit control signaling indicating a set of unevenly spaced time domain occasions within a time duration to monitor for a sensing signal associated with estimating a speed of an object, wherein a first time gap between a first pair of consecutive time domain occasions of the set of unevenly spaced time domain occasions is different than a second time gap between a second pair of consecutive time domain occasions of the set of unevenly spaced time domain occasions;
transmit, within the time duration, a sensing signal via the set of unevenly spaced time domain occasions; and
receive a report indicating a Doppler frequency, an estimated speed of the object corresponding to the Doppler frequency, or both, based at least in part on transmitting the sensing signal.

18. The wireless communication device of claim 17, wherein the report indicates a second Doppler frequency, an estimated speed of a second object corresponding to the second Doppler frequency, or both.

19. The wireless communication device of claim 17, wherein, to transmit the control signaling, the one or more processors are configured to cause the wireless communication device to:
transmit the control signaling indicating an index identifying a position within the time duration for each time domain occasion of the set of unevenly spaced time domain occasions.

20-28. (canceled)

29. A method for wireless communications by a user equipment (UE), comprising:
receiving control signaling indicating a set of unevenly spaced time domain occasions within a time duration to monitor for a sensing signal associated with estimating a speed of an object, wherein a first time gap between a first pair of consecutive time domain occasions of the set of unevenly spaced time domain occasions is different than a second time gap between a second pair of consecutive time domain occasions of the set of unevenly spaced time domain occasions;
monitoring, within the time duration, for a first reflected sensing signal during the set of unevenly spaced time domain occasions; and
transmitting a report indicating a Doppler frequency, an estimated speed of the object corresponding to the Doppler frequency, or both, based at least in part on monitoring for the first reflected sensing signal.

30. (canceled)
